(19) United States
(12) Patent Application Publication
(10) Pub. No.: US 2016/0214104 A1
(43) Pub. Date: Jul. 28, 2016

(54) Fluidic Module, Device and Method for Aliquoting a Liquid

(71) Applicants: Hahn-Schickard-Gesellschaft fuer angewandte Forschung e.V., Villingen-Schwenningen (DE); Albert-Ludwigs-Universitaet Freiburg, Freiburg (DE)

(72) Inventors: Frank SCHWEMMER, Freiburg (DE); Steffen ZEHNLE, Freiburg (DE); Nils PAUST, Freiburg (DE); Pierre Dominique KOSSE, Freiburg (DE); Daniel MARK, Freiburg (DE)

(21) Appl. No.: 15/089,317

(22) Filed: Apr. 1, 2016

Related U.S. Application Data
(63) Continuation of application No. PCT/EP2014/070018, filed on Sep. 19, 2014.

(30) Foreign Application Priority Data
Oct. 1, 2013 (DE) 102013219929.5

(51) Int. Cl. B01L 3/00

(52) U.S. Cl. CPC B01L 3/50273; B01L 3/502715; B01L 3/502746; B01L 2400/0409; B01L 2300/087; B01L 2400/0481; B01L 2300/06; B01L 2200/0605; B01L 2200/0621

(57) ABSTRACT

A fluidic module includes first and second measuring chambers, first and second fluid inlet channels connected to the first and second measuring chambers, respectively, and first and second fluid outlet channels connected to the first and second measuring chambers, respectively. Upon rotation of the fluidic module about a center of rotation, liquids are centrifugally driven into the first and second measuring chambers via the first and second fluid inlet channels, respectively, so that compressible media previously present within the first and second measuring chambers are compressed by the liquids driven into the first and second measuring chambers, respectively. Upon a reduction of the rotational frequency and upon an expansion, resulting therefrom, of the compressible media, the liquids present within the first and second measuring chambers are driven out of same via the first and second fluid outlet channels, respectively.

### CROSS-REFERENCE TO RELATED APPLICATIONS

This application is a continuation of copending International Application No. PCT/EP2014/070018, filed Sep. 19, 2014, which claims priority from German Application No. 10 2013 219 929.5, filed Oct. 1, 2013, which are each incorporated herein in its entirety by this reference thereto.

### BACKGROUND OF THE INVENTION

The present invention relates to a fluidic module, a device for aliquoting a liquid and a method of aliquoting a liquid. Embodiments relate to parallel-pneumatic metering and aliquoting.

In centrifugal microfluidics, rotors are used for processing liquids. Corresponding rotors contain chambers for collecting liquid and channels for directing fluid. While the rotor is being subjected to centripetal acceleration, the liquid is pressed radially outward and can thus arrive at a radially outward position by directing fluid correspondingly. Centrifugal microfluidics is employed, for example, in the field of life sciences, in particular in laboratory analytics. Centrifugal microfluidics serves to automate process flows while replacing operations such as pipetting, mixing, metering, aliquoting and centrifuging.

Aliquoting of liquids may be performed in particular at the beginning, during or at the end of a process chain so as to perform several mutually independent detection reactions (verification reactions) with one sample. For parallelizing laboratory processes within a centrifugal-microfluidic rotor in a fully automated manner, aliquoting processes are therefore indispensable. In this context, certain analysis methods involve not only aliquoting of an individual liquid volume into several aliquots, but also aliquoting of several different liquid volumes, the aliquots of which in turn need to be further processed—e.g., mixed with one another. Quantitatively meaningful analysis processes can be performed only if the aliquots comprise volumes defined as accurately as possible. For this reason, each aliquoting step should also be combined with a metering step. This also applies in case different aliquoting steps take place in parallel within a centrifugal-microfluidic rotor.

Godino et al. [Lab Chip, 2013, 13, 685-69, FIG. 1] describes a metering structure containing a single compression chamber comprising an inlet channel and an outlet channel. The compression chamber consists of two sections extending radially outward (on the left and on the right) and a section extending radially inward. In this context, a defined partial volume can be collected by the left-hand section. Any excess liquid volume exceeding the volume of the left-hand section does not remain within the left-hand section and therefore cannot be separated off either.

However, one possibility of aliquoting defined amounts of liquid is not shown. Moreover, the metering structure taken from Godino et al. is workable only for liquid volumes that have strict upper limits since the overflow structure is contained within the compression chamber. Metering will therefore only work when the overflow chamber is not full. Moreover, said structure allows no aliquoting, as was already mentioned. In addition, the metering structure contains very broad inflow channels, as a result of which the metered volume will highly depend on the input volume.

What is also known is utilizing a compression chamber in combination with fluid channels exhibiting different hydraulic resistances. For example, Zehnle et al. (Lab Chip, 2012, 12, 5142-5145, FIG. 2) shows pumping of liquid within a centrifuge rotor from a radially outward point to a radially inward point without using any external auxiliary devices. However, the fluid structure described there enables neither metering nor aliquoting.

U.S. Pat. No. 5,409,665 describes how end cavities within a centrifugal-microfluidic rotor can be filled, via a supply channel extending radially outward, with ends extending radially inward. In this context, the end cavities are vented, so that air can escape from the end cavities during the filling process. Subsequently, the supernatant liquid above the end cavities is discharged via the supply channel and a siphon.

DE 10 2008 003 979 B3 describes how metering channels within a centrifugal-microfluidic rotor can be filled via a supply channel extending radially inward. The ends of the metering channels have end cavities located thereat. Since the end cavities are not vented, the air which flows from the metering channels into the end cavities while the metering channels are being filled cannot escape and is compressed. While the corresponding pneumatic pressure counteracts the centrifugal pressure of the liquid within the metering channels, the supernatant present will be discharged in the supply channel. By subsequently increasing the rotary frequency of the rotor, the liquid/gas interface between the liquid contained within the metering channels and the air contained within the end cavities becomes unstable, so that the compressed gas will escape from the end cavity through the liquid phase within the metering channel, and so that said liquid phase can be transferred to the end cavity.

In U.S. Pat. No. 5,409,665 and DE 102008003979 B3, aliquots are generated within end cavities. Further fluidic processing of the aliquots is not possible, however.

### SUMMARY

According to an embodiment, a fluidic module may have: a first measuring chamber and a second measuring chamber; a first fluid inlet channel connected to the first measuring chamber and a second fluid inlet channel connected to the second measuring chamber; and a first fluid outlet channel connected to the first measuring chamber and a second fluid outlet channel connected to the second measuring chamber; the fluidic module being configured such that upon rotation of the fluidic module, a liquid is centrifugally driven into the first measuring chamber via the first fluid inlet channel and into the second measuring chamber via the second fluid inlet channel so that a compressible medium previously present within the first measuring chamber and within the second measuring chamber is compressed by the liquid driven into the first measuring chamber and into the second measuring chamber; the fluidic module being configured such that upon a reduction of the rotational frequency and upon an expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid outlet channel; the fluidic module having a fluid manifold, the first fluid inlet channel and the second fluid inlet channel being connected to the fluid manifold.

According to another embodiment, a device for aliquoting a liquid may have: a fluidic module, which may have: a first measuring chamber and a second measuring chamber; a first fluid inlet channel connected to the first measuring chamber and a second fluid inlet channel connected to the second measuring chamber; and a first fluid outlet channel connected to the first measuring chamber and a second fluid outlet channel connected to the second measuring chamber; the fluidic module being configured such that upon rotation of the fluidic module, a liquid is centrifugally driven into the first measuring chamber via the first fluid inlet channel and into the second measuring chamber via the second fluid inlet channel so that a compressible medium previously present within the first measuring chamber and within the second measuring chamber is compressed by the liquid driven into the first measuring chamber and into the second measuring chamber; the fluidic module being configured such that upon a reduction of the rotational frequency and upon an expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid outlet channel; the fluidic module having a fluid manifold, the first fluid inlet channel and the second fluid inlet channel being connected to the fluid manifold; and a drive; the drive being configured to subject, in a first phase, the fluidic module to such a rotational frequency that liquid is centrifugally driven into the first measuring chamber via the first fluid inlet channel and into the second measuring chamber via the second fluid inlet channel, so that a compressible medium previously present within the first measuring chamber and within the second measuring chamber is compressed by the liquid driven into the first measuring chamber and into the second measuring chamber; and the drive being configured to reduce, in a second phase, the rotational frequency to which the fluidic module is subjected to such an extent that due to the reduction of the rotational frequency and to the expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid outlet channel.

According to another embodiment, a method of aliquoting a liquid by means of a fluidic module, which fluidic module may have: a first measuring chamber and a second measuring chamber; a first fluid inlet channel connected to the first measuring chamber and a second fluid inlet channel connected to the second measuring chamber; and a first fluid outlet channel connected to the first measuring chamber and a second fluid outlet channel connected to the second measuring chamber; the fluidic module being configured such that upon rotation of the fluidic module, a liquid is centrifugally driven into the first measuring chamber via the first fluid inlet channel and into the second measuring chamber via the second fluid inlet channel so that a compressible medium previously present within the first measuring chamber and within the second measuring chamber is compressed by the liquid driven into the first measuring chamber and into the second measuring chamber; the fluidic module being configured such that upon a reduction of the rotational frequency and upon an expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid outlet channel; the fluidic module having a fluid manifold, the first fluid inlet channel and the second fluid inlet channel being connected to the fluid manifold, may have the steps of: subjecting the fluidic module to a rotational frequency, so that a liquid is centrifugally driven into the first measuring chamber via the first fluid inlet channel and into the second measuring chamber via the second fluid inlet channel so that a compressible medium previously present within the first measuring chamber and within the second measuring chamber is compressed by the liquid driven into the first measuring chamber and into the second measuring chamber; and reducing the rotational frequency to which the fluidic module is subjected, so that due to the reduction of the rotational frequency and to the expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid outlet channel.

Embodiments of the present invention provide a fluidic module comprising a first measuring chamber, a second measuring chamber, a first fluid inlet channel connected to the first measuring chamber and a second fluid inlet channel connected to the second measuring chamber, a first fluid outlet channel connected to the first measuring chamber and a second fluid outlet channel connected to the second measuring chamber. The fluidic module is configured such that upon rotation of the fluidic module about a center of rotation, a liquid is centrifugally driven into the first measuring chamber via the first fluid inlet channel and into the second measuring chamber via the second fluid inlet channel so that a compressible medium previously present within the first measuring chamber and within the second measuring chamber is compressed by the liquid driven into the first measuring chamber and into the second measuring chamber. The fluidic module is further configured such that upon a reduction of the rotational frequency and upon an expansion, resulting therefrom, of the compressible medium, a large part of the liquid present within the first measuring chamber is driven out of the first measuring chamber via the first fluid outlet channel, and a large part of the liquid present within the second measuring chamber is driven out of the second measuring chamber via the second fluid outlet channel.

Further embodiments provide a device for aliquoting a liquid. The device comprises the above-described fluidic module and a drive. The drive is configured configured to subject, in a first phase, the fluidic module to such a rotational frequency that liquid is centrifugally driven into the first measuring chamber via the first fluid inlet channel and into the second measuring chamber via the second fluid inlet channel, so that a compressible medium previously present within the first measuring chamber and within the second measuring chamber is compressed by the liquid driven into the first measuring chamber and into the second measuring chamber. The drive is further configured to reduce, in a second phase, the rotational frequency to which the fluidic module is subjected to such an extent that due to the reduction of the rotational frequency and to the expansion, resulting therefrom, of the compressible medium, a large part of the liquid present within the first measuring chamber is driven out of the first measuring chamber via the first fluid outlet channel, and a large part of the liquid present within the second measuring chamber is driven out of the second measuring chamber via the second fluid outlet channel.

Further embodiments provide a method of aliquoting a liquid by means of the above-described fluidic module. The method includes subjecting the fluidic module to such a rotational frequency that a liquid is centrifugally driven into the first measuring chamber via the first fluid inlet channel and into the second measuring chamber via the second fluid inlet channel so that a compressible medium previously present within the first measuring chamber and within the second measuring chamber is compressed by the liquid driven into the first measuring chamber and into the second measuring chamber. The method further includes reducing the rotational frequency to which the fluidic module is subjected, so that due to the reduction of the rotational frequency and to the expansion, resulting therefrom, of the compressible medium, a large part of the liquid present within the first measuring chamber is driven out of the first measuring chamber via the first fluid outlet channel, and a large part of the liquid present within the second measuring chamber is driven out of the second measuring chamber via the second fluid outlet channel.

Further embodiments of the present invention provide a fluidic module. The fluidic module comprises a measuring chamber, a compression chamber connected to the measuring chamber via a fluid overflow, a fluid inlet channel connected to the measuring chamber, and a fluid outlet channel connected to the measuring chamber. The fluidic module is configured such that upon a rotation of the fluidic module about a center of rotation, a liquid is centrifugally driven into the measuring chamber via the fluid inlet channel until liquid gets into the compression chamber from the measuring chamber via the fluid overflow and until a compression, caused by the liquid driven into the measuring chamber, of a compressible medium previously present within the measuring chamber, within the compression chamber and within the fluid overflow is sufficiently large so that upon a reduction of a rotational frequency and upon an expansion, resulting therefrom, of the compressible medium, a large part of the liquid present within the measuring chamber is driven out of the measuring chamber via the fluid outlet channel. Moreover, the fluidic module is configured such that upon a reduction of the rotational frequency and upon an expansion, resulting therefrom, of the compressible medium, a large part of the liquid present within the measuring chamber is driven out of the measuring chamber via the fluid outlet channel.

In embodiments, the fluidic module may be configured such that upon a rotation of the fluidic module about a center of rotation, the liquid is driven into the measuring chamber via the fluid inlet channel by a centrifugal pressure caused by the rotation and acting upon the liquid, until liquid from the measuring chamber gets into the compression chamber via the fluid overflow and until a counter pressure resulting from a compression, caused by the liquid driven into the measuring chamber, of a compressible medium previously present within the measuring chamber, within the compression chamber and within the fluid overflow becomes sufficiently large so that upon a reduction of a rotational frequency and upon a reduction, resulting therefrom, of the centrifugal pressure, the compressible medium expands and drives a large part of the liquid present within the measuring chamber out of the measuring chamber via the fluid outlet channel. Moreover, the fluidic module may be configured such that upon the reduction of the rotational frequency and the reduction, caused thereby, of the centrifugal pressure, the compressible medium expands and drives a large part of the liquid present within the measuring chamber out of the measuring chamber via the fluid outlet channel.

Further embodiments provide a device for aliquoting a liquid. The device comprises the above-described fluidic module and a drive. The drive is configured to subject, in a first phase, the fluidic module to such a rotational frequency that the liquid is centrifugally driven into the measuring chamber via the fluid inlet channel until liquid from the measuring chamber gets into the compression chamber via the fluid overflow and until a compression, caused by the liquid driven into the measuring chamber, of a compressible medium previously present within the measuring chamber, within the compression chamber and within the fluid overflow becomes sufficiently large so that upon a reduction of the rotational frequency and upon an expansion, resulting therefrom, of the compressible medium, a large part of the liquid present within the measuring chamber is driven out of the measuring chamber via the fluid outlet channel. Moreover, the drive is configured to reduce, in a second phase, the rotational frequency to which the fluidic module is subjected in such a manner that a large part of the liquid present within the measuring chamber is driven out of the measuring chamber via the outlet channel by the expansion of the compressible medium, which expansion results from the reduction of the rotational frequency.

Further embodiments provide a method of aliquoting a liquid by means of the above-described fluidic module. The method includes subjecting the fluidic module to such a rotational frequency that the liquid is centrifugally driven into the measuring chamber via the fluid inlet channel until liquid from the measuring chamber gets into the compression chamber via the fluid overflow and until a compression, caused by the liquid driven into the measuring chamber, of a compressible medium previously present within the measuring chamber, within the compression chamber and within the fluid overflow becomes sufficiently large so that upon a reduction of the rotational frequency and upon an expansion, resulting therefrom, of the compressible medium, a large part of the liquid present within the measuring chamber is driven out of the measuring chamber via the fluid outlet channel. Moreover, the method includes reducing the rotational frequency to which the fluidic module is subjected, so that a large part of the liquid present within the measuring chamber is driven out of the measuring chamber via the outlet channel by the expansion of the compressible medium, which expansion results from the reduction of the rotational frequency.

### BRIEF DESCRIPTION OF THE DRAWINGS

Embodiments of the present invention will be detailed subsequently referring to the appended drawings, in which:

FIG. 1 shows a schematic side view for illustrating embodiments of the present invention;

FIG. 2 shows a schematic side view for illustrating embodiments of the present invention;

FIG. 3a shows a schematic top view of a detail of a fluidic module in accordance with an embodiment of the present invention;

FIG. 3b shows a schematic top view of a detail of a fluidic module in accordance with an embodiment of the present invention;

FIG. 3c shows a schematic top view of a detail of a fluidic module in accordance with an embodiment of the present invention;

FIG. 3d shows a schematic top view of a detail of a fluidic module in accordance with an embodiment of the present invention;

FIG. 3e shows a schematic top view of a detail of a fluidic module in accordance with an embodiment of the present invention;

FIG. 4a shows a schematic top view of a detail of a fluidic module and a liquid level within the fluidic module at a first point in time, in accordance with an embodiment of the present invention;

FIG. 4b shows a schematic top view of the detail of the fluidic module and a liquid level within the fluidic module at a second point in time, in accordance with an embodiment of the present invention;

FIG. 4c shows a schematic top view of the detail of the fluidic module and a liquid level within the fluidic module at a third point in time, in accordance with an embodiment of the present invention;

FIG. 4d shows a schematic top view of the detail of the fluidic module and a liquid level within the fluidic module at a fourth point in time, in accordance with an embodiment of the present invention;

FIG. 4e shows a schematic top view of the detail of the fluidic module and a liquid level within the fluidic module at a fifth point in time, in accordance with an embodiment of the present invention;

FIG. 4f shows a schematic top view of the detail of the fluidic module and a liquid level within the fluidic module at a sixth point in time, in accordance with an embodiment of the present invention;

FIG. 5 shows a schematic top view of a detail of a fluidic module in accordance with an embodiment of the present invention;

FIG. 6a shows a schematic top view of a partial detail of the fluidic module shown in FIG. 5 and a liquid level within the fluidic module at a first point in time;

FIG. 6b shows a schematic top view of a partial detail of the fluidic module shown in FIG. 5 and a liquid level within the fluidic module at a second point in time;

FIG. 6c shows a schematic top view of a partial detail of the fluidic module shown in FIG. 5 and a liquid level within the fluidic module at a third point in time;

FIG. 6d shows a schematic top view of a partial detail of the fluidic module shown in FIG. 5 and a liquid level within the fluidic module at a fourth point in time;

FIG. 6e shows a schematic top view of a partial detail of the fluidic module shown in FIG. 5 and a liquid level within the fluidic module at a fifth point in time; and

FIG. 7 shows a schematic top view of a detail of a fluidic module.

### DETAILED DESCRIPTION OF THE INVENTION

In the subsequent description of the embodiments of the invention, elements which are identical or have identical actions will be provided with identical reference numerals in the figures, so that their descriptions in the various embodiments are mutually exchangeable.

Before embodiments of the invention will be explained in more detail, it shall initially be pointed out that embodiments of the present invention are employed, in particular, in the field of centrifugal microfluidics, which is about processing of liquids within the nanoliter to milliliter ranges. Accordingly, the fluidic structures may comprise suitable dimensions within the micrometer range for handling corresponding volumes of liquid. The fluidic structures (geometric structures) as well as the pertinent methods are suitable for metering and/or aliquoting liquid within centrifuge rotors.

When the expression radial is used herein, what is meant in each case is radial in relation to the center of rotation about which the fluidic module and/or the rotor is rotatable. Within the centrifugal field, therefore, a radial direction away from the center of rotation is radially falling, and a radial direction toward the center of rotation is radially rising. A fluid channel whose beginning is closer to the center of rotation than is its end, is thus radially falling, whereas a fluid channel whose beginning is further away from the center of rotation than is its end, is radially rising.

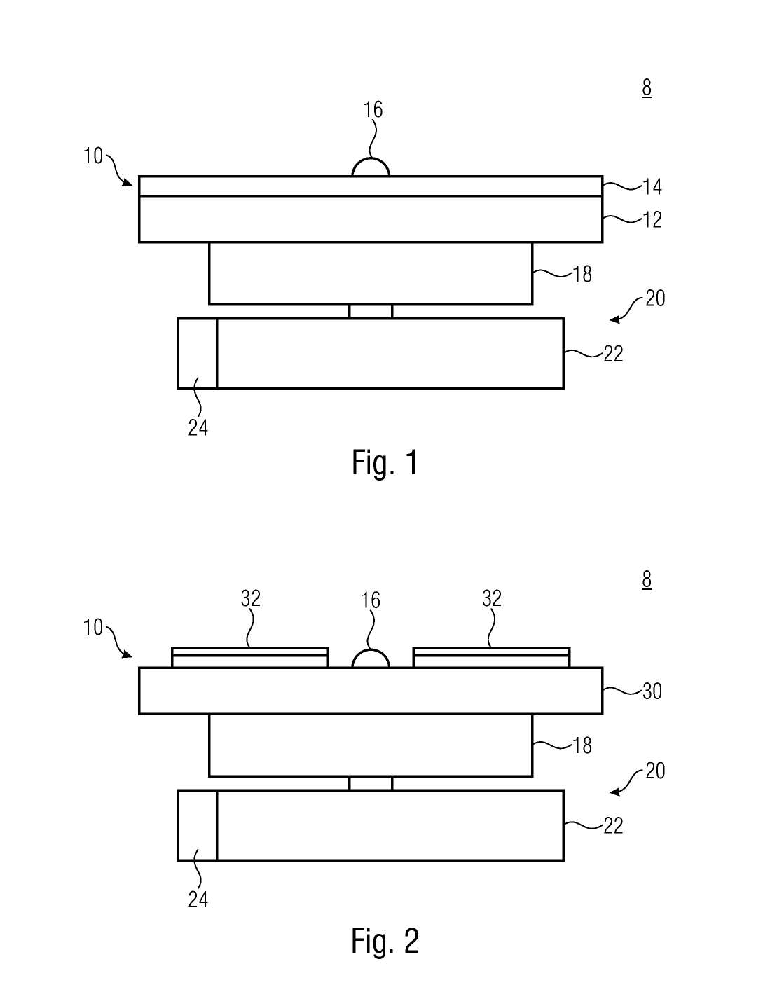

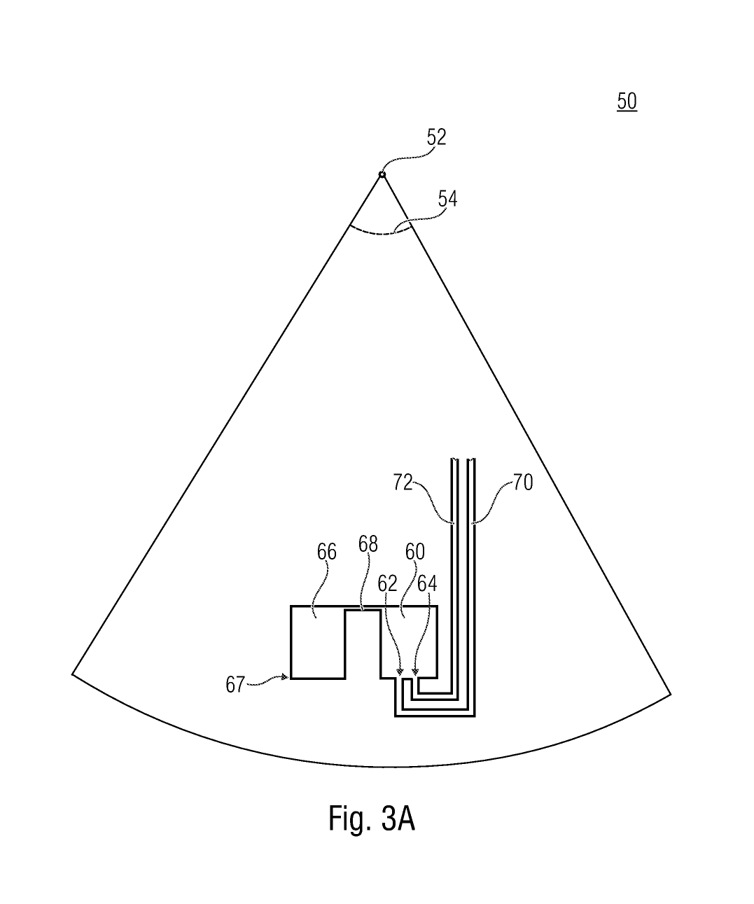

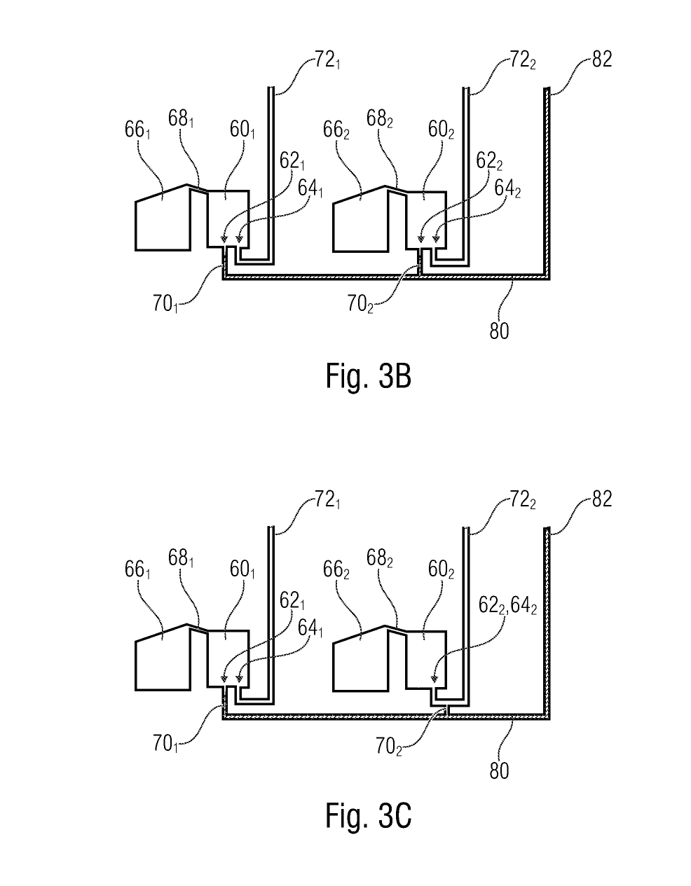

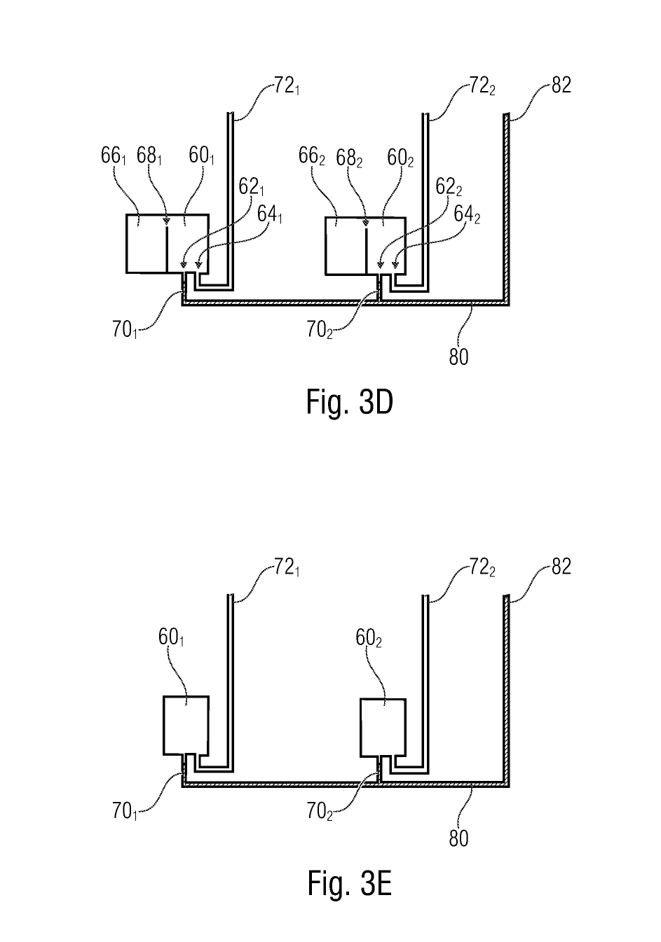

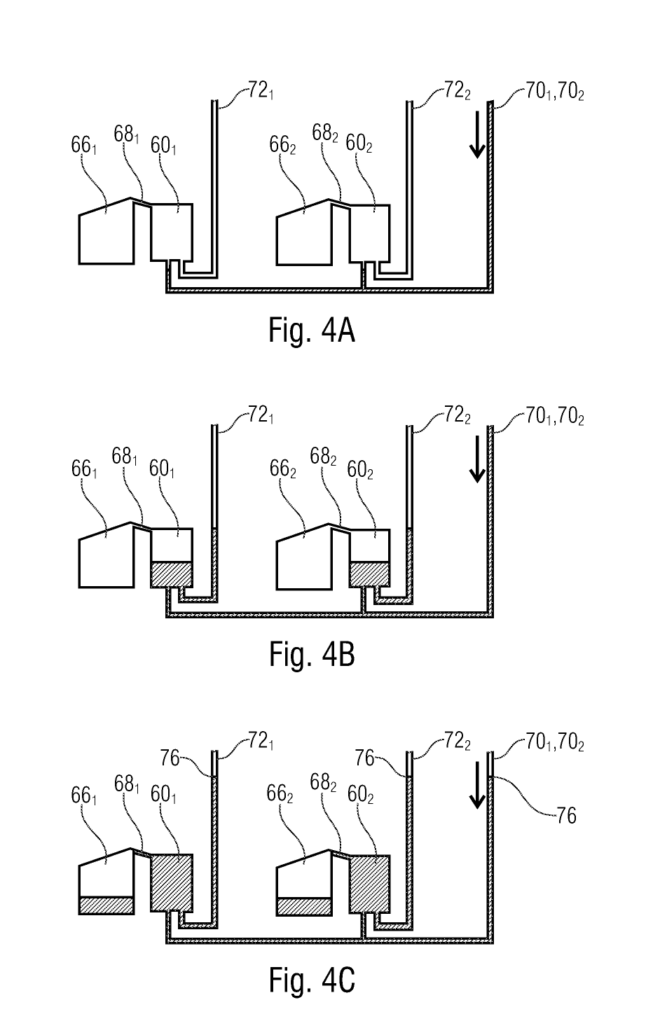

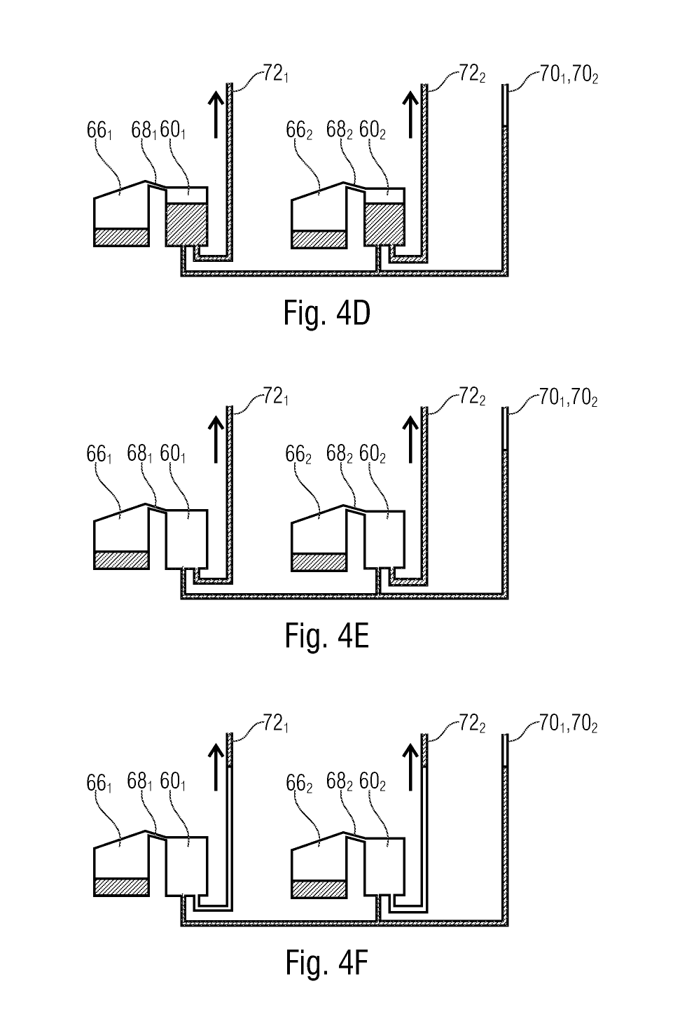

Before an embodiment of a fluidic module having corresponding fluidic structures will be addressed in more detail with reference to FIGS. 3 and 4, embodiments of an inventive device will be described first with reference to FIGS. 1 and 2.

FIG. 1 shows a device 8 comprising a fluidic module 10 in the form of a body of rotation comprising a substrate 12 and a cover 14. The substrate 12 and the cover 14 may be circular in a plan view and comprise a central opening via which the body of rotation 10 may be mounted to a rotating part 18 of a drive device via customary fastening means 16. The rotating part 18 is pivoted on a stationary part 22 of the drive device 20. The drive device may be a conventional centrifuge having an adjustable rotational speed or a CD or DVD drive, for example. Provision may be made of control means 24 configured to control the drive device 20 to subject the body of rotation 10 to rotations at different rotory frequencies. As is obvious to persons skilled in the art, the control means 24 may be implemented, for example, by a computing means programmed accordingly or by an application integrated circuit. The control means 24 may further be configured to control the drive device 20, upon manual inputs on the part of a user, to cause the useful rotations of the body of rotation. In any case, the control means 24 is configured to control the drive device 20 to subject the body of rotation to the rotary frequencies that may be used so as to implement the invention as described herein. As the drive device 20, a conventional centrifuge with only one direction of rotation may be used.

The body of rotation 10 comprises the fluidic structures that may be used. The fluidic structures that may be used may be formed by cavities and channels within the cover 14, the substrate 12 or within the substrate 12 and the cover 14. In embodiments, for example, fluidic structures may be formed within the substrate 12, whereas filler openings and venting openings are formed in the cover 14.

In an alternative embodiment shown in FIG. 2, fluidic modules 32 are inserted into a rotor 30 and form, along with the rotor 30, the body of rotation 10. The fluidic modules 32 may each comprise a substrate and a cover wherein corresponding fluidic structures may be formed in turn. The body of rotation 10 formed by the rotor 30 and the fluidic modules 32 in turn can be subjected to rotation by a drive device 20 controlled by the control means 24.

In embodiments of the invention, the fluidic module and/or the body of rotation which comprises the fluidic structures may be formed of any suitable material, for example a plastic such as PMMA (polymethyl methacrylate, polycarbonate, PVC, polyvinylchloride) or PDMS (polydimethylsiloxane), glass or the like. The body of rotation 10 may be considered as being a centrifugal-microfluidic platform.

FIG. 3a shows a top view of a detail of an inventive fluidic module 50 where a cover has been omitted so that the fluidic structures can be seen. The fluidic module 50 shown in FIG. 3a may have the shape of a disc, so that the fluidic structures are rotatable about a center of rotation 52. The disc may comprise a central hole 54 for being attached to a drive device, as was explained above for example with reference to FIGS. 1 and 2.

The fluidic structures of the fluidic module 50 may comprise a measuring chamber 60, a compression chamber 66 connected to the measuring chamber 60 via a fluid overflow 68, a fluid inlet channel 70 connected to the measuring chamber 60, and a fluid outlet channel 72 connected to the measuring chamber 60.

The fluidic module 50 may be configured such that upon a rotation of the fluidic module 50 about the center of rotation 52, a liquid is centrifugally driven into the measuring chamber 60 via the fluid inlet channel 70 until liquid from the measuring chamber 60 gets into the compression chamber 66 via the fluid overflow 68 and until a compression, caused by the liquid driven into the measuring chamber 60, of a compressible medium previously present within the measuring chamber 60, within the compression chamber 66 and within the fluid overflow 68 is sufficiently large so that upon a reduction of a rotational frequency and upon an expansion, resulting therefrom, of the compressible medium, a large part of the liquid present within the measuring chamber 60 is driven out of the measuring chamber 60 via the fluid outlet channel 72. In this context, the fluidic module 50 may be configured such that upon a reduction of the rotational frequency and upon the expansion, resulting therefrom, of the compressible medium, a large part of the liquid present within the measuring chamber 60 is driven out of the measuring chamber 60 via the fluid outlet channel 72.

In embodiments, the measuring chamber 60, the compression chamber 66 and the fluid overflow 68 may be configured such that upon the rotation of the fluidic module 50 about the center of rotation 52, the liquid is centrifugally driven into the measuring chamber 60 via the fluid inlet channel 70 until liquid from the measuring chamber 60 gets into a portion (e.g., collection area) 67 of the compression chamber 66 via the fluid overflow 68, in which portion the liquid which has got into the portion of the compression chamber 66 is fluidically separate from the liquid present within the measuring chamber 60.

To this end, the fluid overflow 68 may be arranged radially further inward than a radially outward end of the measuring chamber 60. For example, the fluid overflow 68 may be arranged, as can be seen in FIG. 3a, at a radially inward end of the measuring chamber 60 and/or of the compression chamber 66. In this case, the measuring chamber 60 is initially filled (completely) before liquid from the measuring chamber 60 gets to the portion 67 of the compression chamber 66 via the fluid overflow 68.

Moreover, a radially outward end of the compression chamber 66 may be arranged radially further outward than a radially outward end of the measuring chamber 60.

The fluidic module 50 may be configured such that upon the rotation of the fluidic module 50 about the center of rotation 52, the liquid centrifugally driven into the measuring chamber 60 encompasses the compressible medium present within the measuring chamber 60, the compression chamber 66 and the fluid overflow 68.

Prior to filling, i.e., before the liquid is centrifugally driven into the measuring chamber 60, the measuring chamber may also contain (dry or liquid) reagents in addition to the compressible medium. In other words, the measuring chamber 60 may also have (dry or liquid) reagents stored therein.

In embodiments, the measuring chamber 60 may comprise a fluid inlet 62 and a fluid outlet 64, the fluid inlet channel 70 being connected to the measuring chamber 60 via the fluid inlet 62 and the fluid outlet channel 72 being connected to the measuring chamber 60 via the fluid outlet 64. Of course, the measuring chamber 60 may also comprise a combined fluid inlet/fluid outlet 62,64, the fluid inlet channel 70 and the fluid outlet channel 72 being connected to the measuring chamber 60 via the combined fluid inlet/fluid outlet 62,64.

In this context, the fluid outlet 64 of the measuring chamber 60 may be arranged such that the fluid outlet 64 of the measuring chamber 60 is sealed off by the liquid centrifugally driven into the measuring chamber 60. For example, the fluid outlet 64 of the measuring chamber 60 may be arranged at a radially outward end of the measuring chamber 60 (bottom), as is shown in FIG. 3a in accordance with a possible embodiment.

In the embodiment shown in FIG. 3a, the fluid inlet 62 of the measuring chamber is also arranged at the radially outward end of the measuring chamber 60 (bottom). Of course, the fluid inlet 62 of the measuring chamber 60 may also be arranged at a different position, such as at a radially inward end of the measuring chamber 60 (top) or between the radially inward end of the measuring chamber 60 and the radially outward end of the measuring chamber 60.

The fluidic module 50 may further be configured such that upon the rotation of the fluidic module 50 about the center of rotation 52, the amount of liquid centrifugally driven into the measuring chamber 60 is larger than that which can be accommodated by the measuring chamber 60, so that fluid from the measuring chamber 60 gets into the compression chamber 66 via the fluid overflow 68.

For example, the fluid inlet channel 70 may be connected to an inlet area of the fluidic module 50. The inlet area of the fluidic module 50 may be configured such that the former can accommodate a larger volume of the liquid (liquid volume) than the measuring chamber 60.

Of course, the inlet area of the fluidic module 50 may also be configured such that a larger volume of liquid may be introduced into the inlet area of the fluidic module 50 than the measuring chamber 60 can accommodate. For example, the inlet area of the fluidic module 50 may be connected to a liquid chamber, so that prior to and/or upon the rotation of the fluidic module 50 about the center of rotation 52, liquid from the liquid chamber gets into the inlet area of the fluidic module 50. Moreover, the inlet area of the fluidic module 50 may be configured as a liquid reception or be connected to a liquid reception, so that prior to and/or upon the rotation of the fluidic module 50 about the center of rotation 52, liquid may be introduced into the liquid reception.

The measuring chamber 60 may be configured to meter a defined volume of the liquid (liquid volume). The measuring chamber 60 thus may be configured such that it may accommodate a defined and reproducible liquid volume which may subsequently be driven, e.g. via the fluid outlet channel 72, into a chamber connected to the fluid outlet channel 72.

The measuring chamber 60, the compression chamber 66 and the fluid overflow 68 may be configured such that liquid from the measuring chamber 60 does not get into the portion 67 of the compression chamber 66 via the fluid overflow 68 before the measuring chamber 60 has received the volume of the liquid that is to be metered (e.g., before the measuring chamber 60 has been (completely) filled). Any liquid that continues to be centrifugally driven into the measuring chamber 60 thus flows—once the measuring chamber 60 has received the volume of the liquid that is to be metered—from the measuring chamber 60 into the portion 67 of the compression chamber 66 via the fluid overflow 68, so that the filling level within the measuring chamber 60 will not change.

The volume of the liquid (liquid volume) metered by the measuring chamber 60 may be defined by a point of overflow located between the measuring chamber 60 and the compression chamber 66. The point of overflow may be defined, for example, by a mouth of the fluid overflow 68 that opens into the measuring chamber 60, or by a geometric shape of the fluid overflow 68. For example, the fluid overflow 68 may be configured such that same comprises at least one area (point of overflow) located between the measuring chamber 60 and the compression chamber which is arranged radially further inward (i.e., has a smaller distance from the center of rotation) than are the mouths of the fluid overflow 68 that open into the measuring chamber 60 and the compression chamber 66.

By means of the measuring chamber 60, a defined and reproducible liquid volume may thus be metered. Therefore, liquid may be aliquoted by means of the measuring chamber, or, in other words, at least an aliquot part (sub-portion) of the liquid may be metered and subsequently be driven, via the fluid outlet channel 72, into a chamber connected to the fluid outlet channel 72 by means of the expansion of the compressible medium.

However, it shall be pointed out that a quotient of the liquid volume metered by the measuring chamber 60 and of the volume of the liquid (to be metered and/or aliquoted) contained within the inlet area of the fluidic module 50 or introduced into the inlet area of the fluidic module 50 may be integer or non-integer.

So that upon the reduction of the rotational frequency and upon the expansion, resulting therefrom, of the compressible medium, the liquid present within the measuring chamber 60 is (at least largely or predominantly) driven out of the measuring chamber 60 via the fluid outlet channel 72, the fluidic module 50 may be configured such that a fluidic resistance of the fluid inlet channel 70 is larger than a fluidic resistance of the fluid outlet channel 72. Of course, the fluidic module 50 may also be configured such that a fluidic resistance of the fluid inlet 62 of the measuring chamber 60 is larger than a fluidic resistance of the fluid outlet 64 of the measuring chamber 60.

Moreover, the fluidic module 50 may be configured such that upon the reduction of the rotational frequency and upon the expansion, resulting therefrom, of the compressible medium, the liquid present within the measuring chamber 60 is (almost) completely driven out of the measuring chamber 60.

In this context it shall be noted that even following complete expansion of the compressible medium, a (negligible) portion of the liquid may remain, or linger, within the measuring chamber 60, so that the liquid is not completely, but almost completely driven out of the measuring chamber 60, e.g., in an amount of at least 90% (or 80%, 85%, 95%, 99%).

Moreover, it shall be noted that a (negligible) portion of the liquid may also be driven out of the measuring chamber 60 via the fluid inlet channel 70. In this context, the fluidic module 50 may be configured such that the liquid is largely, e.g., in an amount of at least 90% (or 80%, 85%, 95%, 99%), driven out of the measuring chamber 60 via the fluid outlet channel 72.

For example, the fluidic module 50 may be configured such that upon the reduction of the rotational frequency, the liquid that has got into the compression chamber 66 remains within the compression chamber 66, so that upon the reduction of the rotational frequency and upon the expansion, resulting therefrom, of the compressible medium, the liquid present within the measuring chamber 60 is (almost) completely driven out of the measuring chamber 60. The liquid remaining within the compression chamber 66 thus takes up a part of the volume of the compression chamber 66. Upon the reduction of the rotational frequency and upon the expansion, resulting therefrom, of the compressible medium, the compressible medium thus will have less volume within the compression chamber 66 available to it than it did before, whereby an excess volume fraction, resulting from the liquid remaining within the compression chamber 66, of the compressible medium exits the measuring chamber 60 via the fluid outlet channel 72 while being able to not only drive the liquid out of the measuring chamber 60 (almost) completely, but being able to (almost) completely drive the liquid, via the fluid outlet channel 72 (if a length of the fluid outlet channel 72 is dimensioned accordingly), into a chamber connected to the fluid outlet channel 72.

As can be seen in FIG. 3a, the fluid overflow 68 may be configured as a fluid overflow channel connecting the measuring chamber 60 and the compression chamber 66. The fluid overflow channel 68 may be arranged radially further inward than an outer end of the measuring chamber 60 and/or of the compression chamber 66, for example. For example, the fluid overflow channel 68 may be arranged at a radially inward end of the measuring chamber 60 and/or of the compression chamber 68. Of course, in some embodiments the overflow channel 68 may also be arranged at a radially outward end of the measuring chamber 60 and/or of the compression chamber 66.

FIG. 3b shows a schematic top view of a detail of a fluidic module 50 in accordance with an embodiment of the present invention.

As was already described with reference to FIG. 3a, the fluidic module 50 may comprise a (first) measuring chamber 60₁ having a fluid inlet and a fluid outlet, a (first) compression chamber 66₁ connected to the (first) measuring chamber 60₁ via a (first) fluid overflow 68₁, a (first) fluid inlet channel 70₁ connected to the fluid inlet of the (first) measuring chamber 60₁, and a (first) fluid outlet channel 72₁ connected to the fluid outlet of the (first) measuring chamber 60₁.

As can additionally be seen in FIG. 3b, the fluidic module 50 may comprise a second measuring chamber 60₂ having a fluid inlet and a fluid outlet, a second compression chamber 66₂ connected to the second measuring chamber 60₂ via a second fluid overflow 68₂, a second fluid inlet channel 70₂ connected to the fluid inlet of the second measuring chamber 60₂, and a second fluid outlet channel 72₂ connected to the fluid outlet of the second measuring chamber 60₂.

Generally, the fluidic module 50 may comprise at least one further measuring chamber 60₂ to 60ₙ having a fluid inlet and a fluid outlet, at least a further compression chamber 66₂ to 66ₙ connected to the at least one further measuring chamber 60₂ to 60ₙ via at least one further fluid overflow 68₂ to 68ₙ, at least one further fluid inlet channel 70₂ to 70ₙ connected to the fluid inlet of the at least one further measuring chamber 60₂ to 60ₙ, and at least one further fluid outlet channel 72₂ to 72ₙ connected to the fluid outlet of the at least one further measuring chamber 60₂ to 60ₙ.

The fluidic module 50 shown in FIG. 3b comprises, by way of example, two measuring chambers 60₁ to 60ₙ (n=2) with associated compression chambers 66₁ to 66ₙ (n=2), fluid overflows 68₁ to 68ₙ (n=2), fluid inlet channels 70₁ to 70ₙ (n=2) and fluid outlet channels 72₁ to 72ₙ (n=2). Of course, the fluidic module 50 may comprise up to n measuring chambers 60₁ to 60ₙ with associated compression chambers 66₁ to 66ₙ, fluid overflows 68₁ to 68ₙ, fluid inlet channels 70₁ to 70ₙ and fluid outlet channels 72₁ to 72ₙ, n being a natural number larger than or equal to 1, n≧1.

In accordance with the mode of operation already described with reference to FIG. 3a, the fluidic module 50 may be configured such that upon the rotation of the fluidic module 50 about the center of rotation 52, a liquid is centrifugally driven into the at least one further measuring chamber 60₂ to 60ₙ (n=2) via the at least one further fluid inlet channel 70₂ to 70ₙ (n=2) until liquid from the at least one further measuring chamber 60₂ to 60ₙ (n=2) gets into the at least one further compression chamber 66₂ to 66ₙ (n=2) via the at least one further fluid overflow 68₂ to 68ₙ (n=2) and until a compression, caused by the liquid driven into the at least one further measuring chamber 60₂ to 60ₙ (n=2), of a compressible medium previously present within the at least one further measuring chamber 60₂ to 60ₙ (n=2), within the at least one further compression chamber 66₂ to 66ₙ (n=2) and within the at least one further fluid overflow 68₂ to 68ₙ (n=2) is sufficiently large so that upon the reduction of the rotational frequency and upon an expansion, resulting therefrom, of the compressible medium, the liquid present within the at least one further measuring chamber 60₂ to 60ₙ (n=2) is driven out of the at least one further measuring chamber 60₂ to 60ₙ (n=2) via the at least one further fluid outlet channel 72₂ to 72ₙ (n=2). Moreover, the fluidic module 50 may be configured such that upon the reduction of the rotational frequency and upon the expansion, resulting therefrom, of the compressible medium, the liquid present within the at least one further measuring chamber 60₂ to 60ₙ (n=2) is driven out of the at least one further measuring chamber 60₂ to 60ₙ (n=2) via the at least one further fluid outlet channel 72₂ to 72ₙ (n=2).

In embodiments, the fluidic module 50 may comprise a fluid manifold 80, the fluid inlet channel 70₁ and the at least one further fluid inlet channel 70₂ to 70ₙ (n=2) being connected to the fluid manifold 80. The fluid inlet channel 70₁ and the at least one further fluid inlet channel 70₂ to 70ₙ may comprise fluidic resistances higher than those of the fluid manifold 80₁ to 80₂.

For example, the fluid inlet channel 70₁ and the at least one further fluid inlet channel 70₂ to 70ₙ each may comprise a fluidic resistance that is higher by at least a factor of 5 (or 10, 15, 20 or more) than that of the fluid manifold 80.

Moreover, the fluidic module 50 may comprise a fluid inlet connected to the fluid manifold 80 via a fluid channel 82. The fluid channel 82 may comprise a fluidic resistance higher than that of the fluid manifold 80.

For example, the fluid channel 82 may have a fluidic resistance that is higher by at least a factor of 5 (or 10, 15, 20 or more) than that of the fluid manifold 80.

In other words, the filling channels (fluid inlet channels 70₁ to 70ₙ and manifold 80) may be subdivided into areas having low and high fluidic resistances. In this manner, uniform filling of the measuring chambers (measuring cavities) 60₁ to 60ₙ (n=2) as well as fluidic decoupling of the measuring chambers (measuring cavities) 60₁ to 60ₙ (n=2) upon emptying by the fluid outlet channels 72₁ to 72ₙ (n=2) can be ensured. By the areas having low fluidic resistances it may be ensured that the measuring chamber 60ₙ contains a volume similar to that of the measuring chamber 60₁.

As can be seen in FIG. 3b, the fluid inlet channels 70₁ to 70ₙ (n=2) may form inflows which connect the manifold (or auxiliary channel) 80 to the measuring chambers 60₁ to 60ₙ. The inflows 70₁ to 70ₙ (n=2) may have a high fluidic resistance. The manifold (or auxiliary channel) 80, which connects the inflows 70₁ to 70ₙ (n=2) of the measuring chambers 60₁ to 60, (n=2) to the fluid channel (inlet channel) 82, may comprise a low fluidic resistance. The fluid channel (inlet channel) 82 may connect the filling channels to the fluidic inlet; the fluid channel (inlet channel) 82 may have a high fluidic resistance (not mandatorily a high resistance).

FIG. 3c shows a schematic top view of a detail of a fluidic module 50 in accordance with an embodiment of the present invention.

As can be seen in FIG. 3c, the measuring chamber 60₁ comprises a fluid inlet 62₁ and a fluid outlet 64₁, the fluid inlet channel 70₁ being connected to the measuring chamber 60₁ via the fluid inlet 62₁, and the fluid outlet channel 72₁ being connected to the measuring chamber 60₁ via the fluid outlet 64₁.

In contrast to this, the measuring chamber 60₂ comprises a combined fluid inlet/fluid outlet 62₂,64₂, the fluid inlet channel 70 and the fluid outlet channel 72 being connected to the measuring chamber 60₂ via the combined fluid inlet/fluid outlet 62₂,64₂.

In this context, the fluid inlet channel 70 and the fluid outlet channel 72 may be directly connected to the combined fluid inlet/fluid outlet 62,64, i.e., in each case directly open into the measuring chamber 60 via the combined fluid inlet/fluid outlet 62,64. Of course, the fluid inlet channel 70 and the fluid outlet channel 72 may also be joined upstream from the combined fluid inlet/fluid outlet 62,64.

For example, the fluid inlet channel 70 and the fluid outlet channel 72 may be joined by means of a fluid channel piece (e.g., T-piece or Y-piece), the fluid channel piece being directly connected to the combined fluid inlet/fluid outlet 62,64.

Moreover, the fluid inlet channel 70 may be directly connected to the combined fluid inlet/fluid outlet 62,64, while the fluid outlet channel 72 is connected to the combined fluid inlet/fluid outlet 62,64 via the fluid inlet channel 70, i.e., the fluid outlet channel 72 initially opens into the fluid inlet channel 70.

Furthermore, the fluid outlet channel 72 may be directly connected to the combined fluid inlet/fluid outlet 62,64, while the fluid inlet channel 70 is connected to the combined fluid inlet/fluid outlet 62,64 via the fluid outlet channel, i.e., the fluid inlet channel 70 initially opens into the fluid outlet channel 72.

FIG. 3d shows a schematic top view of a detail of a fluidic module 50 in accordance with an embodiment of the present invention. As can be seen in FIG. 3d, the measuring chambers 60₁ to 60ₙ (n=2) and the compression chambers 66₁ to 66ₙ (n=2) may be arranged immediately adjacent to one another; it is possible for the fluid overflows 68₁ to 68ₙ (n=2) to be formed not only by channels (e.g., capillaries) as shown above, but also by discontinuous partition walls between measuring chambers 60₁ to 60ₙ (n=2) and compression chambers 66₁ to 66ₙ (n=2).

FIG. 3e shows a schematic top view of a detail of a fluidic module 50 in accordance with an embodiment of the present invention. The fluidic module 50 may comprise a measuring chamber 60₁, at least one further measuring chamber 60₂ (n=2), a fluid inlet channel 70₁ connected to the measuring chamber 60₁, at least one further fluid inlet channel 70₂ (n=2) connected to the at least one further measuring chamber 60₂ (n=2), a fluid outlet channel 72₁ connected to the measuring chamber 60₁, and at least one further fluid outlet channel 72₂ (n=2) connected to the at least one further measuring chamber 60₂ (n=2).

The fluidic module 50 may be configured such that upon a rotation of the fluidic module 50 about the center of rotation 52, a liquid is centrifugally driven into the measuring chamber 60₁ via the fluid inlet channel 70₁ and into the at least one further measuring chamber 60ₙ (n=2) via the at least one further fluid inlet channel 70ₙ (n=2), so that a compressible medium previously present within the measuring chamber 60₁ and within the at least one further measuring chamber 60ₙ (n=2) is compressed by the liquid driven into the measuring chamber 60₁ and into the at least one further measuring chamber 60ₙ (n=2). The fluidic module 50 may further be configured such that upon a reduction of the rotational frequency and upon an expansion, resulting therefrom, of the compressible medium, a large part of the liquid present within the measuring chamber 60₁ is driven out of the measuring chamber 60₁ via the fluid outlet channel 72₁ and a large part of the liquid present within the at least one further measuring chamber 60ₙ (n=2) is driven out of the at least one further measuring chamber 60ₙ (n=2) via the at least one further fluid outlet channel 72ₙ (n=2).

The mode of operation of the fluidic module 50 shown in FIG. 3b shall be explained in more detail below with reference to FIGS. 4a to 4f. FIGS. 4a to 4f each show a schematic top view of the fluidic module 50 shown in FIG. 3b as well as liquid levels within the fluidic module 50 at six different points in time. However, it shall be noted that the description which follows is also applicable to the fluidic modules 50 shown in FIGS. 3a and 3b to 3e.

The fluidic module 50 shown in FIGS. 4a to 4f may be used for aliquoting liquid. In this context, individual volumes (of the liquid to be aliquoted) may be metered under high centrifugation, and in this manner, a compressed compressible medium (e.g., compressed air) which has been compressed under centrifugation by the liquid to be metered may be separated and be directed onward within chambers connected to the fluid outlet channels (e.g., subsequent chambers).

To this end, liquid is transferred from an inlet area of the fluidic module 50 into different measuring chambers (measuring cavities or metering cavities) 60₁ to 60ₙ (n=2) under centrifugation. Each measuring chamber 60₁ to 60ₙ (n=2) is configured such that when being filled with liquid under centrifugation, a volume of a compressible medium (e.g., air volume) will be trapped and compressed. The liquid therefore can flow in for such time until a pneumatic counter-pressure equivalent to the centrifugal pressure has been built up. The measuring chamber 60₁ to 60ₙ (n=2) may be configured such that normally, the amount of liquid flowing in is larger than that to be metered. Any excess liquid flows from the measuring chamber 60₁ to 60ₙ (n=2) via a point of overflow and remains within the compression chamber 66₁ to 66ₙ (n=2), which forms a separate collection area.

Different output volumes generate different counter-pressures due to different levels of compression of the compressible medium (e.g., air). This results in that the filling levels within the fluid inlet channels (filling channels) 70₁ to 70ₙ (n=2) and the fluid outlet channels (channels to subsequent cavities) 72₁ to 72ₙ (n=2) depend on the input volume. In order to achieve as high a level of measurement accuracy as possible it is therefore useful to generate as small interfaces 76 as possible in fluid inlet channels 70₁ to 70ₙ (n=2) and fluid outlet channels 72₁ to 72ₙ (n=2) that are narrowed accordingly (see FIG. 4c). Ideally, the diameters of the fluid inlet channels 70₁ to 70ₙ (n=2) and of the fluid outlet channels 72₁ to 72ₙ (n=2) should be smaller by at least a factor of five than dimensions (e.g., diameter or diagonal) of the measuring chamber 60₁ to 60ₙ (n=2).

If the rotational frequency (or centrifugation speed) is reduced, the centrifugal pressure will decrease. Due to the lower pressure, the compressed volume of the compressible medium (e.g., air volume) expands, and the metered liquid is forwarded from the measuring chambers 60₁ to 60ₙ (n=2) into subsequent chambers via channels 70₁ to 70ₙ (n=2). The aliquots thus forwarded will then be defined in terms of their volumes and can be used for further processes.

Since liquid will remain within the compression chamber (collection area) 66₁ to 66ₙ (n=2), the volume of liquid that is pumped on during this metering process is smaller than that of compressible medium (e.g., air) which has been compressed. Moreover, the geometric configuration of the measuring chamber 60₁ to 60ₙ (n=2) and of the fluid inlet channels (filling channels) 70₁ to 70ₙ (n=2) 70 may be selected such that the compressible medium (e.g., air) escapes advantageously through the fluid outlet channel 72₁ to 72ₙ (n=2). Consequently, the measuring chamber 60₁ to 60ₙ (n=2) may thus be completely emptied even if the fluid outlet channel 72₁ to 72ₙ (n=2) points radially inward.

Thus, the interplay with any further aliquoting structure results in the possibility of aliquoting several liquids into split end cavities in parallel without involving several fluidic layers. In known aliquoting principles, this is possible only to a very limited extent because of channel crossings.

When manufacturing a physical fluid structure, the various channels for forwarding will not be exactly identical. As a result, the fluidic resistances of the fluid inlet channels 70₁ to 70ₙ (n=2) and of the fluid outlet channels 72₁ to 72ₙ (n=2) will vary, and there will be inaccuracies regarding emptying. To minimize said inaccuracies it is useful to reduce or even minimize fluidic communication between the measuring chambers 60₁ to 60ₙ (n=2). This may be effected, for example, in that the fluid inlet channel (filling channel) 70₁ to 70ₙ (n=2) has a fluidic resistance substantially higher than that of the fluid outlet channels 72₁ to 72ₙ (n=2) for forwarding the liquid/directing the liquid onward.

In the following, the mode of operation of the fluidic module 50 shall be described in more detail with reference to FIGS. 4a to 4f, which show the liquid levels within the fluidic module 50 at six different points in time.

The fluidic module 50 shall be subjected, for example by the drive 20 described with reference to FIGS. 1 and 2, to a first rotational frequency f₁ in a first phase (FIGS. 4a to 4c), while the fluidic module 50 is subjected to a second rotational frequency f₂ in a second phase (FIGS. 4d to 4f). The second rotational frequency f₂ is smaller than the first rotational frequency f₁, f₁>f₂.

FIG. 4a shows a schematic top view of the fluidic module 50 and a liquid level within the fluidic module 50 at a first point in time. At the first point in time, the fluidic module 50 is subjected to the first rotational frequency f₁, whereby the liquid present, e.g., within an inlet area of the fluidic module 50 or is introduced into the inlet area of the fluidic module 50 is centrifugally driven toward the measuring chambers 60₁ to 60ₙ (n=2) via the fluid inlet channels 70₁ to 70ₙ (n=2) connected, e.g., to the inlet area of the fluidic module 50, which results in the liquid level shown in FIG. 4a.

FIG. 4b shows a schematic top view of the fluidic module 50 and a liquid level within the fluidic module 50 at a second point in time. At the second point in time, the fluidic module 50 continues to be subjected to the first rotational frequency f₁, whereby the liquid is centrifugally driven into the measuring chambers 60₁ to 60ₙ (n=2) via the fluid inlet channels 70₁ to 70ₙ (n=2), so that the liquid level within the measuring chambers 60₁ to 60ₙ (n=2) has risen as compared to the liquid level shown in FIG. 4a.

In this process, as can be seen in FIG. 4b, the compressible medium previously present within the measuring chambers 60₁ to 60ₙ (n=2), within the fluid overflows 68₁ to 68ₙ (n=2) and within the compression chambers 62₁ to 62ₙ (n=2) is trapped and compressed by the liquid centrifugally driven into the measuring chambers 60₁ to 60ₙ (n=2), whereby a pressure of the compressible medium rises. In other words, a volume that is available to the compressible medium is reduced by the liquid volume centrifugally driven into the measuring chambers 60₁ to 60ₙ (n=2), as a result of which the pressure of the compressible medium rises.

FIG. 4c shows a schematic top view of the fluidic module 50 and a liquid level within the fluidic module 50 at a third point in time. At the third point in time, the fluidic module 50 continues to be subjected to the first rotational frequency f₁, whereby the liquid continues to be centrifugally driven into the measuring chambers 60₁ to 60ₙ (n=2) via the fluid inlet channels 70₁ to 70ₙ, so that by the third point in time, the liquid level within the measuring chambers 60₁ to 60ₙ (n=2) has risen up to the point of overflow and liquid from the measuring chambers 60₁ to 60ₙ has got into the compression chambers 66₁ to 66ₙ (n=2) (n=2) via the fluid overflows 68₁ to 68ₙ (n=2).

As compared to FIG. 4b, in FIG. 4c the volume available to the compressible medium was further reduced by the liquid volume centrifugally driven into the measuring chambers 60₁ to 60ₙ (n=2) and now extends only to part of the compression chambers 66₁ to 66ₙ (n=2), which, with regard to FIG. 4b, results in a further increase in the pressure of the compressible medium.

FIG. 4d shows a schematic top view of the fluidic module 50 and a liquid level within the fluidic module 50 at a fourth point in time. Between the third and the fourth points in time, the rotational frequency to which the fluidic module 50 is subjected has been reduced from the first rotational frequency f₁ to the second rotational frequency f₂, which results in an expansion of the compressible medium, whereby the liquid present within the measuring chambers 60₁ to 60ₙ (n=2) is driven out of the measuring chambers 60₁ to 60ₙ (n=2) via the fluid outlet channels 72₁ to 72ₙ (n=2), while the liquid that previously got into the compression chambers 66₁ to 66ₙ (n=2) remains within the compression chambers 66₁ to 66ₙ (n=2).

FIG. 4e shows a schematic top view of the fluidic module 50 and a liquid level within the fluidic module 50 at a fifth point in time. At the fifth point in time, the fluidic module 50 continues to be subjected to the second rotational frequency f₂, whereby the compressible medium expands further, so that the liquid present within the measuring chambers 60₁ to 60ₙ (n=2) is (almost) completely driven out of the measuring chambers 60₁ to 60ₙ (n=2) via the fluid outlet channels 72₁ to 72ₙ (n=2).

FIG. 4f shows a schematic top view of the fluidic module 50 and a liquid level present within the fluidic module 50 at a sixth point in time. At the sixth point in time, the fluidic module 50 continues to be subjected to the second rotational frequency f₂. Due to the liquid remaining within the compression chambers 66₁ to 66ₙ (n=2), the compressible medium expands further, so that the liquid cannot only be (almost) completely driven out of the measuring chambers 60₁ to 60ₙ (n=2) via the fluid outlet channels 72₁ to 72ₙ (n=2) but may even be (almost) completely driven into downstream chambers connected with the fluid outlet channels 72₁ to 72ₙ (n=2) (provided that a length of the fluid outlet channels 72₁ to 72ₙ (n=2) is configured accordingly).

In other words, due to the liquid volume remaining within the compression chambers 66₁ to 66ₙ (n=2), the liquid volume metered within the measuring chambers 60₁ to 60ₙ (n=2) may be (almost) completely driven, due to the expansion of the compressible medium, into downstream chambers connected to the fluid outlet channels 72₁ to 72ₙ (n=2).

Thus, the fluidic module 50 as shown in FIGS. 4a to 4f can be filled under centrifugation (see FIG. 4a). Once a first liquid volume has flowed into the measuring chambers 60₁ to 60ₙ (n=2), the hermetically entrapped volume V of the compressible medium (e.g., air volume) will be compressed (see FIG. 4b). Any excess liquid flows from the measuring chambers 60₁ to 60ₙ (n=2) into the compression chambers (e.g., collection cavity) 66₁ to 66ₙ (n=2) via the fluid overflows 68₁ to 68ₙ (n=2) (see FIG. 4c). While the rotational frequency (rotational speed) is reduced, the compressible medium (e.g., entrapped air) relaxes, and the liquid is forwarded into subsequent chambers through the fluid outlet channels 72₁ to 72ₙ (n=2) (see FIGS. 4d and 4e). Due to the liquid remaining within the compression chambers 66₁ to 66ₙ (n=2), there will still be excess pressure within the compression chambers 66₁ to 66ₙ (n=2) even at the fifth point in time. This results in that even the liquid volume remaining within the fluid outlet channels 72₁ to 72ₙ (n=2) can be transported into subsequent chambers (or cavities).

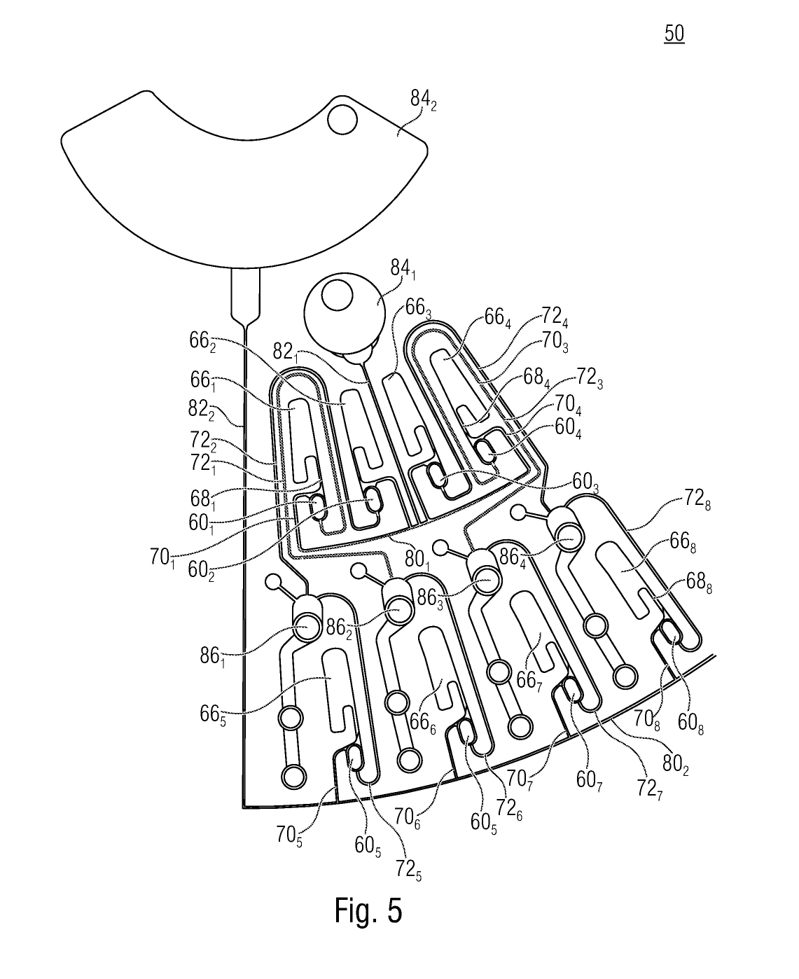

FIG. 5 shows a schematic top view of a detail of a fluidic module 100 in accordance with an embodiment of the present invention. The fluidic module 50 shown in FIG. 5 comprises eight measuring chambers 60₁ to 60ₙ (n=8) with associated compression chambers 66₁ to 66ₙ (n=8), fluid overflows 68₁ to 68, (n=8), fluid inlet channels 70₁ to 70, (n=8) and fluid outlet channels 72₁ to 72ₙ (n=8).

The eight measuring chambers 60₁ to 60, (n=8) are subdivided into a first half of measuring chambers 60₁ to 60₄ and a second half of measuring chambers 60₅ to 60₈, the first half of measuring chambers 60₁ to 60₄ being arranged radially further inward than the second half of measuring chambers 60₅ to 60₈.

The fluid inlet channels 70₁ to 70₄ of the first half of measuring chambers 60₁ to 60₄ are connected to a first inlet area 84₁ of the fluidic module 50 via a first manifold 80₁ and a first radially extending channel 82₁, while the fluid inlet channels 70₅ to 70₈ of the second half of measuring chambers 60₅ to 60₈ are connected to a second inlet area 84₂ of the fluidic module 50 via a second manifold 80₂ and a second radially extending channel 82₂.

The fluid outlet channels 70₁ to 70₄ of the first half of measuring chambers 60₁ to 60₄ and the fluid outlet channels 70₅ to 70₈ of the second half of measuring chambers 60₅ to 60₈ are connected in pairs, respectively, to a (downstream) chamber 86₁ to 86₄.

In detail, the first fluid outlet channel 72₁ and the fifth fluid outlet channel 72₅ are connected to the first (downstream) chamber 86₁, while the second fluid outlet channel 72₂ and the sixth fluid outlet channel 72₆ are connected to the second (downstream) chamber 86₂, while the third fluid outlet channel 72₃ and the seventh fluid outlet channel 72₇ are connected to the third (downstream) chamber 86₃ and while the fourth fluid outlet channel 72₄ and the eighth fluid outlet channel 72₈ are connected to the fourth (downstream) chamber 86₄.

For example, the fluidic module 50 may be used for mixing liquids in that a first liquid is introduced into the first inlet area 84₁ and a second liquid is introduced into the second inlet area 84₂, so that upon the reduction of the rotational frequency and the associated expansion of the compressible medium into the (downstream) chambers 86₁ to 86₄, an aliquot of the first liquid and a aliquot of the second liquid are centrifugally driven, respectively.

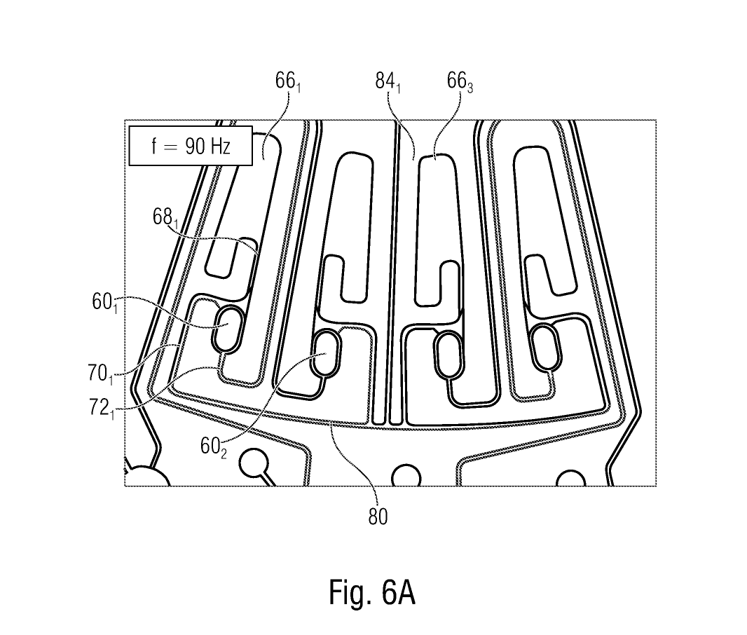

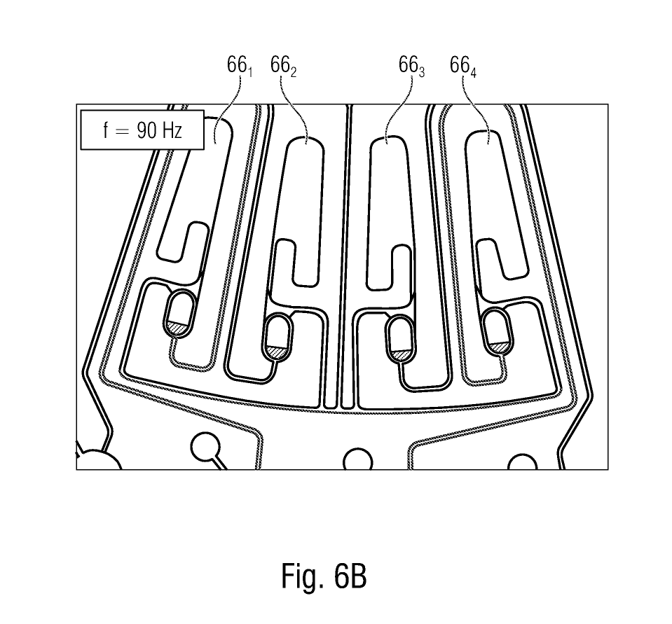

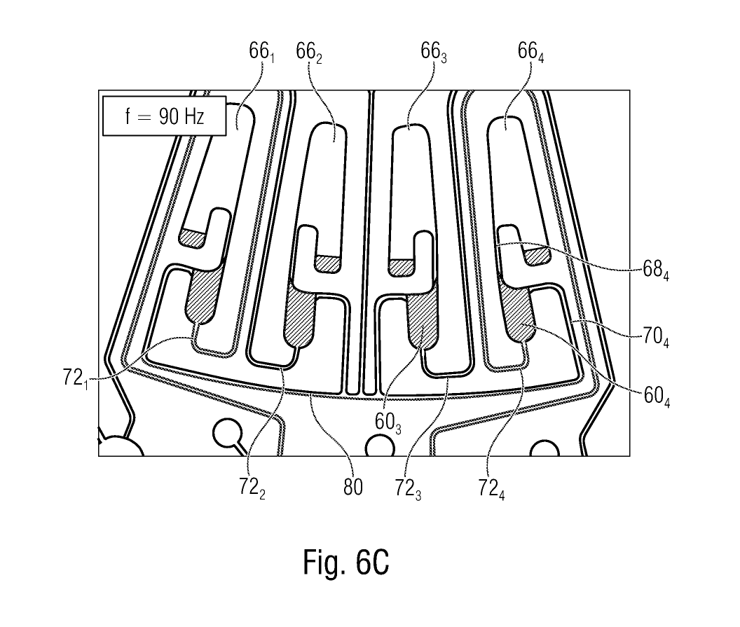

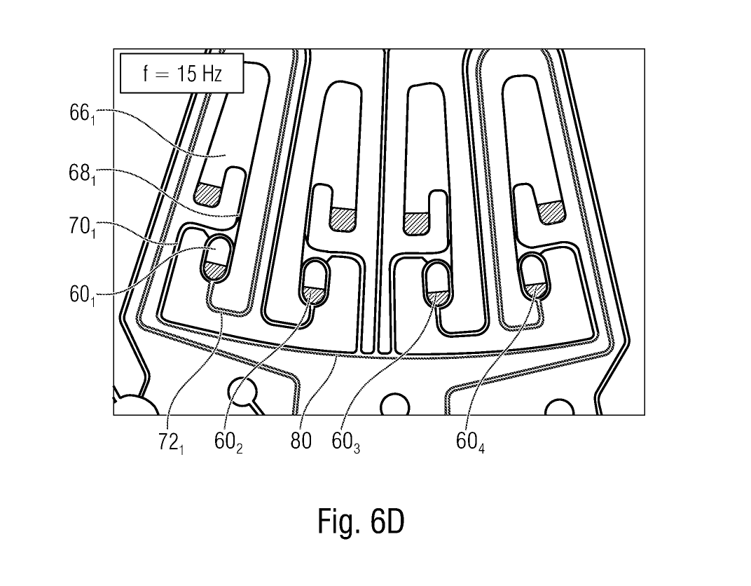

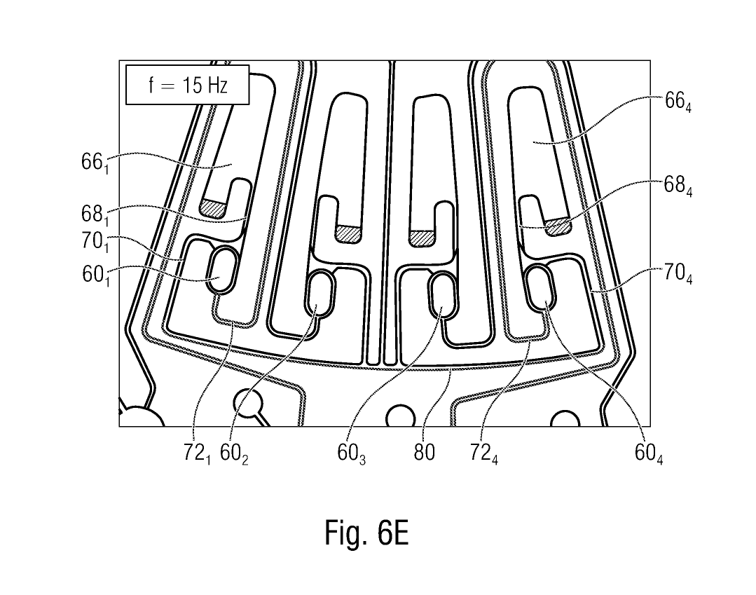

In the following, the mode of operation of the fluidic module 50 shown in FIG. 5 will be explained in more detail by means of FIGS. 6a to 6e, which show liquid levels within the fluidic module 50 at five different points in time.

FIG. 6a shows a schematic top view of a partial detail of the fluidic module 50 and a liquid level within the fluidic module 50 at a first point in time. At the first point in time, the fluidic module 50 is subjected to a first rotational frequency f₁ (e.g., f, =90 Hz).

FIG. 6b shows a schematic top view of the partial detail of the fluidic module 50 and a liquid level within the fluidic module 50 at a second point in time. At the second point in time, the fluidic module 50 continues to be subjected to the first rotational frequency f₁, whereby the liquid is centrifugally driven into the measuring chambers 60₁ to 60₄ via the fluid inlet channels 70₁ to 70₄, which results in the liquid level shown in FIG. 4b.

FIG. 6c shows a schematic top view of the partial detail of the fluidic module 50 and a liquid level within the fluidic module 50 at a third point in time. At the third point in time, the liquid module 50 continues to be subjected to the first rotational frequency f₁, whereby the liquid continues to be centrifugally driven into the measuring chambers 60₁ to 60₄ via the fluid inlet channels 70₁ to 70₄, so that by the third point in time, liquid has already got into the compression chambers 66₁ to 66₄ from the measuring chambers 60₁ to 60₄ via the fluid overflows 68₁ to 68₄.

FIG. 6d shows a schematic top view of the partial detail of the fluidic module 50 and a liquid level within the fluidic module 50 at a fourth point in time. Between the third and fourth points in time, the rotational frequency to which the fluidic module 50 is subjected has been reduced from the first rotational frequency f₁ (e.g., f₁=90 Hz) to the second rotational frequency f₂ (e.g., f₂=15 Hz), which leads to an expansion of the compressible medium, whereby the liquid present within the measuring chambers 60₁ to 60₄ is driven out of the measuring chambers 60₁ to 60₄ via the fluid outlet channels 72₁ to 72₄, while the liquid that previously got into the compression chambers 66₁ to 66₄ remains within the compression chambers 66₁ to 66₄.

FIG. 6e shows a schematic top view of the partial detail of the fluidic module 50 and a liquid level within the fluidic module 50 at a fifth point in time. At the fifth point in time, the fluidic module 50 continues to be subjected to the second rotational frequency f₂, whereby the compressible medium has expanded to such an extent that the liquid present within the measuring chambers 60₁ to 60ₙ (n=2) has been (almost) completely driven out of the measuring chambers 60₁ to 60₄ via the fluid outlet channels 72₁ to 72₄.

In other words, FIGS. 6a to 6d show an exemplary course of the aliquoting process. Under a high rotational frequency (centrifugation) of, e.g., 90 Hz, a first liquid flows, via a manifold 80₁, from an inlet area 84₁ into four measuring chambers 60₁ to 60₄ having a volume of about 5 μl through a channel 82₁ leading radially outward.

The fluid inlet channel 70₁ to 70₄ leading to the measuring chamber 60₁ to 60₄ may be configured to start at the top end of the measuring chamber 60₁ to 60₄ (not mandatory). The fluid outlet channel 72₁ to 72₄ is then hermetically sealed by a first portion of the inflowing liquid. Thus, further inflowing liquid will then (at least partly) compress the entrapped compressible medium (e.g., gas volume) within the compression chamber (pressure chamber) 66₁ to 66₄ (see FIG. 6b).

The liquid keeps on flowing until the inlet area 84₁ has been emptied completely. Each of the measuring chambers 60₁ to 60₄ has a compression chamber (pressure chamber) 66₁ to 66₄ connected to it wherein a defined volume of the compressible medium (e.g., air volume) is entrapped. Excess liquid keeps flowing into the drain areas of the individual compression chambers (pressure chambers) 66₁ to 66₄ until the inlet area 84₁ has been emptied (not mandatory). Now a balance between the centrifugal force and the pneumatic counter-pressure is achieved.

If the rotary frequency is reduced, the entrapped compressible medium (e.g., air volume) within the compression chamber (pressure chamber 206) will expand under the lower centrifugal pressure. As a result, the liquid column within the radially extending channel 82₁ and within the fluid outflow channel 72₁ to 72₄, which may be configured as a siphon, for example, increases in turn. From a specific fill height, the filling level exceeds the crest of the siphon 72₁ to 72₄, and the liquid is transported on. Due to the centrifugal force and excess pressure, the liquid is now completely transferred from the measuring chambers 60₁ to 60₄ into the chambers 86₁ to 86₄.

Due to the fact that the fluid inlet channel (filling channel) 70₁ to 70₄ starts at the top end of the measuring chamber 60₁ to 60₄, the liquid remains within the fluid inlet channels 70₁ to 70₄ and is not distributed to the measuring chambers 60₁ to 60₄.

The accuracy of the aliquoting process will be particularly high when the fluid inlet channels 70₁ to 70₄ and the fluid outlet channels 72₁ to 72₄ are small as compared to the measuring chamber 60₁ to 60₄. Inaccuracies in measurement arise, e.g., due to the fact that different starting conditions such as the input volume, manufacturing tolerances, etc., result in differences in the filling levels during the metering step. As a result, the metering accuracy is directly correlated to the dimensions of the fluid inlet channels 70₁ to 70₄ and of the fluid outlet channels 72₁ to 72₄. In this context, smaller dimensions will result in more accurate metering.

Further measuring errors arise during emptying of the measuring chambers (measuring cavities) 60₁ to 60₄. Since there may be a difference in pressure between the measuring chambers 60₁ to 60₄, there may be an exchange of liquid between the measuring chambers 60₁ to 60₄. To minimize this, it is possible, on the one hand, for the fluid outlet channel (e.g., siphon) 72₁ to 72₄ to have a fluidic resistance much smaller than the sum of resistances of the fluid inlet channels 70₁ to 70₄, and it is possible, on the other hand, for the fluid inlet channel (filling channel) 70₁ to 70₄ to start at a radially inward point of the measuring chamber 60₁ to 60₄. As a result, the measuring chambers 60₁ to 60₄ are not in fluidic communication at least during a certain emptying period. During this time, thus, potential pressure differences will not cause any additional errors.

The above-described aliquoting concepts (radially inward aliquoting) may also be used for aliquoting liquids from radially outward to radially further inward by making small changes (radially outward aliquoting). In this context, the siphon 72₁ to 72₄ may be replaced by a fluid outlet channel 72₅ to 72₈ leading inward (see FIG. 5). The input volume of the liquid per measuring chamber (aliquoting chamber) 60₁ to 60₄ may be configured such that (virtually) all of the liquid present within the measuring chamber 60₁ to 60₄ and all of the liquid present within the fluid outlet channel 72₅ to 72₈ is transferred into a subsequent chamber 86₁ to 86₄ located further inward.

By combining the two above-described aliquoting concepts (radially inward aliquoting and radially outward aliquoting), an aliquoting concept may be devised which aliquots two liquids on one fluidic layer. The overall structure may then be configured, e.g., such that an aliquot from a first aliquoting structure (first half of the measuring chambers 60₁ to 60₄) and an aliquot from a second aliquoting structure (second half of measuring chambers 60₅ to 60₈), respectively are transferred into a shared chamber (cavity) 86₁ to 86₄. The subsequent chamber (cavity) 86₁ to 86₄ may be a mixing chamber 86₁ to 86₄. The entire circumference around the axis of rotation may potentially be used for fluidic structures.

The aliquoting concept presented herein generally is also suited for aliquoting on a disc structured in a multi-layered manner. The disc may be configured such that the liquid for filling may be guided over a fluidic layer A and in the process may potentially be directed past crossing channels. The chamber is now emptied via a channel on the fluidic layer B. This channel may be both a siphon (e.g., 72₁ to 72₄) and a different channel leading radially inward, for example (e.g., 72₅ to 72₈). Other than that, the aliquoting process takes place as was described with regard to radially inward aliquoting. This is the obvious process to be performed, e.g., when the number of aliquots for the radially inward liquid is high (>10) and, as a result, the adjacently arranged siphon structures (72₁ to 72₄) can no longer be introduced in a spatially efficient manner. Moreover, such a configuration is advantageous as soon as more than two liquids are aliquoted into one chamber (cavity) 86₁ to 86₄. The fluidic connection may be realized either within the measuring chamber 60₁ to 60₈ itself or within a fluidic opening specifically provided for this purpose. It is possible to either provide each measuring chamber 60₁ to 60₈ with a fluidic opening of its own or for several measuring chambers 60₁ to 60₈ to share one fluidic opening.

Embodiments of the present invention enable simultaneous, parallel aliquoting of two liquids on a fluidic layer. Measuring, or metering, of the volumes takes place at high pressures, whereby capillary forces have little influence. Moreover, embodiments enable a potentially high level of accuracy since metering of the liquids takes place at high rotational frequencies. In addition, embodiments can dispense with sharp edges.

Unlike known aliquoting methods, the metering step of embodiments is performed at “high” rotational frequencies (rotary frequencies) and is subsequently switched to low rotational frequencies (rotary frequencies). Unlike known fluidic structures, the fluidic structure described herein is still functional even in the event of heavy overfilling (>50% of the volume measured). Unlike known aliquoting concepts, the aliquoting concept described herein enables aliquoting and connecting two liquids on one fluidic layer. Unlike known fluidic structures, in the fluidic structure described herein, the liquid may be supplied to the measuring chambers from outside and, additionally, the liquid may subsequently be processed further. Unlike known fluidic structures, at least two aliquots may have a waste cavity connected (directly or via a channel) to said metering chamber, which may be exploited, e.g., for performing individual quality control on each single aliquot by reading out the filling level within the waste cavity. Unlike known fluidic structures, in the fluidic structure described herein, the measuring chambers are separated from one another by a fluidic resistance higher than that of the channel used for forwarding the aliquots.

Further embodiments provide a fluidic structure comprising a fluid inlet channel (fluid inlet) having a high fluidic resistance, a fluid outlet channel (fluid outlet) having a low fluidic resistance, a measuring chamber and a compression chamber (pressure chamber), which are separated by a fluid overflow (fluid channel). The fluidic structure is configured such that upon filling of the fluidic structure, a compressible medium (e.g., air volume) is entrapped and that the volume of liquid introduced is larger than that encompassed by the volume of the measuring chamber, whereby excess liquid flows into the compression chamber (pressure chamber) through the fluid overflow and remains there; upon reduction of the rotational frequency (rotary frequency), a defined amount of liquid now directed through the fluid outlet channel (outlet).

Further embodiments provide a fluidic structure and a method of aliquoting several aliquots, the metering step being performed at “high” rotational frequencies (rotary frequencies), and forwarding of the liquids taking place at low rotary frequencies. The fluidic structure may be configured such that upon filling of the measuring chamber, a compressible medium (e.g., air) is compressed within the compression chamber. Moreover, the fluidic structure may be configured such that the fluid inlet of the measuring chamber comprises a fluidic resistance higher than that of the fluid outlet of the measuring chamber. Furthermore, the fluidic structure may be configured such that at least two aliquots comprise a waste cavity connected (directly or via a channel) to said measuring chamber. In addition, the fluidic structure may be configured such that during the volume-determining metering step, the meniscus is present only in such channels which are small as compared to the measuring chamber. Moreover, the fluidic structure may be configured such that the volume-determining measuring chamber is filled to a level of more than 50% (70%, 90%, completely). Furthermore, the fluidic structure may be configured such that during emptying, an interface between the compressible medium and the liquid (e.g., air/water interface) is displaced radially inward. Moreover, the fluidic structure may be configured such that at least one measuring chamber is filled from a radially further inward direction and is emptied in a radially further outward direction.

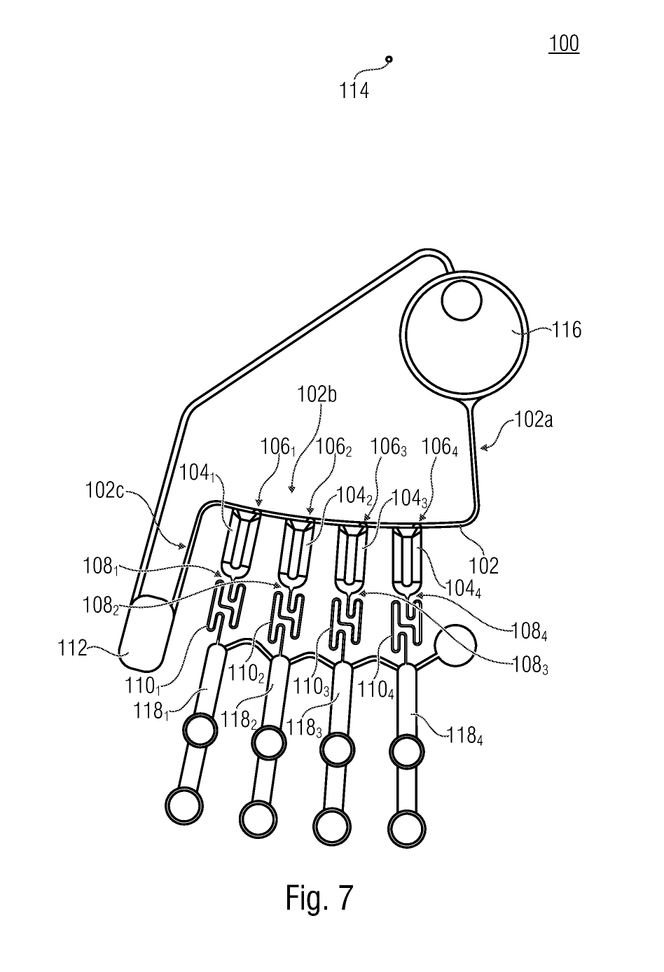

FIG. 7 shows a schematic top view of a detail of a fluidic module 100. The fluidic module 100 includes a fluid inlet channel 102, at least one measuring chamber 104₁ to 104ᵢ comprising a fluid inlet 106₁ to 106ᵢ and a fluid outlet 108₁ to 108ᵢ, at least one fluid resistance element 110₁ to 110ᵢ and an overflow 112, the fluid inlet channel 102 being connected to the at least one measuring chamber 104₁ to 104ᵢ via the fluid inlet 106₁ to 106ᵢ and to the overflow 112, and the at least one fluid resistance element 110₁ to 110ᵢ being connected to the at least one measuring chamber 104₁ to 104ᵢ via the fluid outlet 108₁ to 108ᵢ. The fluidic module 100 is configured such that upon rotation of the fluidic module about a center of rotation 114 and upon a centrifugal pressure resulting therefrom, a liquid is centrifugally driven into the at least one measuring chamber 104₁ to 104ᵢ via the fluid inlet channel 102, the at least one fluid resistance element 110₁ to 110ᵢ comprising a fluidic resistance higher than a fluidic resistance of the fluid inlet channel 102 and than a fluidic resistance of the fluid inlet 104₁ to 104ᵢ, so that the volume of liquid driven into the at least one measuring chamber 104₁ to 104ᵢ is larger than the volume of liquid that exits the at least one measuring chamber 104₁ to 104ᵢ via the at least one fluid resistance element 110₁ to 110ᵢ, so that the at least one measuring chamber 104₁ to 104ᵢ is filled and excess liquid gets into the overflow 112. The fluidic module 100 may further be configured such that upon an increase in the rotational frequency (e.g. by at least a factor of 2 (or 3, 4, 5, 7, 10)) and upon an increase, resulting therefrom, of the centrifugal pressure, the liquid present within the at least one measuring chamber 104₁ to 104ᵢ is driven out of the measuring chamber 104₁ to 104ᵢ via the at least one variable fluid resistance element 110₁ to 110ᵢ faster than was the case prior to the increase in the rotational frequency.

It shall be noted that the rotational frequency need not be increased in order for the liquid present within the at least one measuring chamber 104₁ to 104ᵢ to be centrifugally driven out of same. The increase in the rotational frequency results in an increase in the centrifugal pressure, so that the liquid present within the at least one measuring chamber 104₁ to 104ᵢ can be driven out of same faster.

Moreover, the fluidic module 100 may comprise an inlet area 116 connected to the fluid inlet channel 102.

A first portion 102a of the fluid inlet channel 102 may be connected to the inlet area 116 and may extend from radially further inward to radially further outward. A second portion 102b of the fluid inlet channel 102, to which the at least one measuring chamber 104₁ to 104ᵢ may be connected, may extend laterally (e.g. have a uniform radial distance from the center of rotation 114). A third portion 102c of the fluid inlet channel 102 may extend from radially further inward to radially further outward and may be connected to the overflow 112.

Moreover, the fluidic module 100 may comprise at least one further chamber 118₁ to 118₄ connected to an output of the at least one variable fluid resistance element 110₁ to 110ᵢ, the at least one measuring chamber 104₁ to 104ᵢ being connected to the at least one variable fluid resistance element 110₁ to 110ᵢ via an input of the at least one variable fluid resistance element 110₁ to 110ᵢ.

In other words, FIG. 7 shows a fluidic structure 100 (metering structure or aliquoting structure) comprising an inlet area 116, a filling and overflow channel 102, a measuring chamber 104₁ to 104ᵢ, a valve 110₁ to 110ᵢ and an overflow 112, the valve 110₁ to 110ᵢ not closing completely but having liquid flow through it continuously.

In this context, the flow resistance of the valve 110₁ to 110ᵢ is sufficiently high so that at a first rotational frequency f1, the velocity at which the liquid fills the measuring chamber 104₁ to 104ᵢ and at which excess liquid drains into the overflow area 112 from the inlet area 116 via the overflow channel 102 is much higher than that at which liquid is forwarded into a subsequent chamber 118₁ to 118, downstream from the valve 110₁ to 110ᵢ. Typically, the process of dividing the liquid would be at least 10 times (or, better, 100 times) faster than forwarding the liquid. As a result, the volume accuracy of metering is ensured without involving a valve 110₁ to 110ᵢ which would completely prevent the flow of liquid during the filling process.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device. Some or all of the method steps may be performed by a hardware device (or while using a hardware device), such as a microprocessor, a programmable computer or an electronic circuit. In some embodiments, some or several of the most important method steps may be performed by such a device.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A fluidic module comprising:
a first measuring chamber and a second measuring chamber;
a first fluid inlet channel connected to the first measuring chamber and a second fluid inlet channel connected to the second measuring chamber; and
a first fluid outlet channel connected to the first measuring chamber and a second fluid outlet channel connected to the second measuring chamber;
the fluidic module being configured such that upon rotation of the fluidic module, a liquid is centrifugally driven into the first measuring chamber via the first fluid inlet channel and into the second measuring chamber via the second fluid inlet channel so that a compressible medium previously present within the first measuring chamber and within the second measuring chamber is compressed by the liquid driven into the first measuring chamber and into the second measuring chamber;
the fluidic module being configured such that upon a reduction of the rotational frequency and upon an expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid outlet channel;
the fluidic module comprising a fluid manifold, the first fluid inlet channel and the second fluid inlet channel being connected to the fluid manifold.

2. The fluidic module as claimed in claim 1, the fluidic module further comprising a first compression chamber and a second compression chamber, the first compression chamber and the first measuring chamber being connected to each other via a first fluid overflow, and the second compression chamber and the second measuring chamber being connected to each other via a second fluid overflow;
the fluidic module being configured such that upon the rotation of the fluidic module, the liquid is centrifugally driven into the first measuring chamber via the first fluid inlet channel and into the second measuring chamber via the second fluid inlet channel until liquid gets into a portion of the first compression chamber from the first measuring chamber via the first fluid overflow, in which portion it is separate from the liquid present within the first measuring chamber, and gets into a portion of the second compression chamber from the second measuring chamber via the second fluid overflow, in which portion it is separate from the liquid present within the second measuring chamber, and until a compression, caused by the liquid driven into the first measuring chamber, of a compressible medium previously present within the first measuring chamber, within the first compression chamber and within the first fluid overflow and a compression, caused by the liquid driven into the second measuring chamber, of a compressible medium previously present within the second measuring chamber, within the second compression chamber and within the second fluid overflow is sufficiently large so that upon a reduction of a rotational frequency and upon an expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid overflow.

3. The fluidic module as claimed in claim 1, wherein fluidic resistances of the first fluid inlet channel and of the second fluid inlet channel are larger, due to the geometric configuration, than fluidic resistances of the first fluid outlet channel and of the second fluid outlet channel.

4. The fluidic module as claimed in claim 1, wherein a dimension of the first fluid inlet channel and of the second fluid inlet channel is smaller by at least a factor of five than a dimension of the first measuring chamber and of the second measuring chamber, and/or wherein a diameter of the first fluid outlet channel and of the second fluid outlet channel is smaller by at least a factor of five than a diameter or a diagonal of the first measuring chamber and of the second measuring chamber.

5. The fluidic module as claimed in claim 2, the fluidic module being configured such that upon the rotation of the fluidic module, the liquid centrifugally driven into the first measuring chamber encompasses the compressible medium present within the first measuring chamber, within the first compression chamber and within the first fluid overflow, and the liquid centrifugally driven into the second measuring chamber encompasses the compressible medium present within the second measuring chamber, within the second compression chamber and within the second fluid overflow.

6. The fluidic module as claimed in claim 2, the fluidic module being configured such that upon the rotation of the fluidic module, the amount of liquid centrifugally driven into the first measuring chamber and into the second measuring chamber is larger than that which can be accommodated by the first measuring chamber and the second measuring chamber, so that liquid gets into the first compression chamber from the first measuring chamber via the first fluid overflow and gets into the second compression chamber from the second measuring chamber via the second fluid overflow.

7. The fluidic module as claimed in claim 1, the fluidic module being configured such that upon the reduction of the rotational frequency and upon the expansion, resulting therefrom, of the compressible medium, the liquid present within the first measuring chamber is driven out of the first measuring chamber via the first fluid outlet channel and the liquid present within the second measuring chamber is driven out of the second measuring chamber via the second fluid outlet channel for such time until at least part of an excess volume fraction of the compressible medium exits the first measuring chamber via the first fluid outlet channel and exits the second measuring chamber via the second fluid outlet channel.

8. The fluidic module as claimed in claim 2, the fluidic module being configured such that upon the reduction of the rotational frequency, the liquid that has got into the first compression chamber remains within the first compression chamber and the liquid that has got into the second compression chamber remains within the second compression chamber.

9. The fluidic module as claimed in claim 8, the fluidic module being configured such that upon the reduction of the rotational frequency, the liquid that has got into the first compression chamber remains within the first compression chamber and the liquid that has got into the second compression chamber remains within the second compression chamber, so that upon the reduction of the rotational frequency and upon the expansion, resulting therefrom, of the compressible medium, the liquid present within the first measuring chamber is driven out of the first measuring chamber via the first fluid outlet channel and the liquid present within the second measuring chamber is driven out of the second measuring chamber via the second fluid outlet channel for such time until at least part of an excess volume fraction of the compressible medium exits the first measuring chamber via the first fluid outlet channel and exits the second measuring chamber via the second fluid outlet channel.

10. The fluidic module as claimed in claim 8, wherein the first and second fluid inlet channels and the first and second fluid outlet channels are configured such that upon the expansion of the compressible medium, an excess volume fraction, which results from the liquid remaining within the first and second compression chambers, of the compressible medium exits the first measuring chamber via the first fluid outlet channel and exits the second measuring chamber via the second fluid outlet channel in an amount of at least 70%.

11. The fluidic module as claimed in claim 8, the fluidic module being configured such that upon the reduction of the rotational frequency, the liquid that has got into the first compression chamber remains within the first compression chamber and the liquid that has got into the second compression chamber remains within the second compression chamber, so that upon the reduction of the rotational frequency and upon the expansion, resulting therefrom, of the compressible medium, the liquid present within the first measuring chamber is driven, via the first fluid outlet channel, into a first chamber connected to the first fluid outlet channel, and the liquid present within the second measuring chamber is driven, via the second fluid outlet channel, into a second chamber connected to the second fluid outlet channel.

12. The fluidic module as claimed in claim 1, wherein the first measuring chamber and the second measuring chamber are configured to each meter a volume of the liquid.

13. The fluidic module as claimed in claim 2, wherein the first measuring chamber and the second measuring chamber are configured to each meter a volume of the liquid, wherein the first fluid overflow defines the volume metered by the first measuring chamber and the second fluid overflow defines the volume metered by the second measuring chamber.

14. The fluidic module as claimed in claim 2, wherein the first measuring chamber comprises a first fluid inlet and a first fluid outlet, and the second measuring chamber comprises a second fluid inlet and a second fluid outlet, the first fluid inlet and the second fluid inlet being arranged radially further inward than are the first fluid outlet and the second fluid outlet, the first fluid inlet channel being connected to the first measuring chamber via the first fluid inlet, the second fluid inlet channel being connected to the second measuring chamber via the second fluid inlet, the first fluid outlet channel being connected to the first measuring chamber via the first fluid outlet, and the second fluid outlet channel being connected to the second measuring chamber via the second fluid outlet.

15. The fluidic module as claimed in claim 14, wherein the first fluid outlet is radially arranged at an outer end of the first measuring chamber and the second fluid outlet is radially arranged at an outer end of the second measuring chamber, and/or wherein the first fluid inlet is radially arranged at an inner end of the first measuring chamber and the second fluid inlet is radially arranged at an inner end of the second measuring chamber.

16. The fluidic module as claimed in claim 1, wherein the first measuring chamber comprises a combined fluid inlet/fluid outlet and the second measuring chamber comprises a second combined fluid inlet/fluid outlet, the first fluid inlet channel and the first fluid outlet channel being connected to the first measuring chamber via the first combined fluid inlet/fluid outlet, and the second fluid inlet channel and the second fluid outlet channel being connected to the second measuring chamber via the second combined fluid inlet/fluid outlet; in the first and second combined fluid inlets/fluid outlets, the respective fluid outlet channel opens into the respective fluid inlet channel.

17. The fluidic module as claimed in claim 1, wherein the first fluid outlet channel and the second fluid outlet channel each comprise a siphon.

18. The fluidic module as claimed in claim 1, wherein fluidic resistances of the first fluid outlet channel and of the second fluid outlet channel each are smaller than a sum of the fluidic resistances of the first fluid inlet channel and the second fluid inlet channel.

19. The fluidic module as claimed in claim 1, wherein the first fluid inlet channel and the second fluid inlet channel each comprise a fluidic resistance higher than that of the fluid manifold.

20. The fluidic module as claimed in claim 19, the fluidic module comprising a fluid inlet connected to the fluid manifold via a fluid channel, the fluid channel comprising a fluidic resistance higher than that of the fluid manifold.

21. The fluidic module as claimed in claim 1, the fluidic module being configured such that upon the rotation of the fluidic module, a first liquid is driven into the first measuring chamber and a second liquid is driven into the second measuring chamber, the first fluid outlet channel and the second fluid outlet channel being connected to a mixing chamber.

22. The fluidic module as claimed in claim 21, wherein the first measuring chamber and the first compression chamber are arranged radially further inward than are the second measuring chamber and the second compression chamber.

23. A device for aliquoting a liquid, comprising:
a fluidic module comprising:
a first measuring chamber and a second measuring chamber;
a first fluid inlet channel connected to the first measuring chamber and a second fluid inlet channel connected to the second measuring chamber; and
a first fluid outlet channel connected to the first measuring chamber and a second fluid outlet channel connected to the second measuring chamber;
the fluidic module being configured such that upon rotation of the fluidic module, a liquid is centrifugally driven into the first measuring chamber via the first fluid inlet channel and into the second measuring chamber via the second fluid inlet channel so that a compressible medium previously present within the first measuring chamber and within the second measuring chamber is compressed by the liquid driven into the first measuring chamber and into the second measuring chamber;
the fluidic module being configured such that upon a reduction of the rotational frequency and upon an expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid outlet channel;
the fluidic module comprising a fluid manifold, the first fluid inlet channel and the second fluid inlet channel being connected to the fluid manifold;
and
a drive;
the drive being configured to subject, in a first phase, the fluidic module to such a rotational frequency that liquid is centrifugally driven into the first measuring chamber via the first fluid inlet channel and into the second measuring chamber via the second fluid inlet channel, so that a compressible medium previously present within the first measuring chamber and within the second measuring chamber is compressed by the liquid driven into the first measuring chamber and into the second measuring chamber; and
the drive being configured to reduce, in a second phase, the rotational frequency to which the fluidic module is subjected to such an extent that due to the reduction of the rotational frequency and to the expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid outlet channel.

24. A method of aliquoting a liquid by means of a fluidic module comprising:
a first measuring chamber and a second measuring chamber;
a first fluid inlet channel connected to the first measuring chamber and a second fluid inlet channel connected to the second measuring chamber; and
a first fluid outlet channel connected to the first measuring chamber and a second fluid outlet channel connected to the second measuring chamber;
the fluidic module being configured such that upon rotation of the fluidic module, a liquid is centrifugally driven into the first measuring chamber via the first fluid inlet channel and into the second measuring chamber via the second fluid inlet channel so that a compressible medium previously present within the first measuring chamber and within the second measuring chamber is compressed by the liquid driven into the first measuring chamber and into the second measuring chamber;
the fluidic module being configured such that upon a reduction of the rotational frequency and upon an expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid outlet channel;
the fluidic module comprising a fluid manifold, the first fluid inlet channel and the second fluid inlet channel being connected to the fluid manifold,
the method comprising:
subjecting the fluidic module to a rotational frequency, so that a liquid is centrifugally driven into the first measuring chamber via the first fluid inlet channel and into the second measuring chamber via the second fluid inlet channel so that a compressible medium previously present within the first measuring chamber and within the second measuring chamber is compressed by the liquid driven into the first measuring chamber and into the second measuring chamber; and
reducing the rotational frequency to which the fluidic module is subjected, so that due to the reduction of the rotational frequency and to the expansion, resulting therefrom, of the compressible medium, the liquid present within the first measuring chamber is driven out of the first measuring chamber via the first fluid outlet channel, and the liquid present within the second measuring chamber is driven out of the second measuring chamber via the second fluid outlet channel.
